(19) United States
(12) Patent Application Publication
(10) Pub. No.: US 2023/0302398 A1
(43) Pub. Date: Sep. 28, 2023

(54) A METHOD AND SYSTEM FOR THE REMOVAL OF CARBON DIOXIDE FROM SOLVENTS USING LOW-GRADE HEAT

(71) Applicant: CARBON CLEAN SOLUTIONS LIMITED, Berkshire (GB)

(72) Inventors: Prateek BUMB, Greater London (GB); James HALL, Greater London (GB); Ausula RAMESH-KUMAR, Mumbai (IN); Gopinath KARUPPASAMY, Tamil Nadu (IN); David BAHR, Chicago, IL (US); Richard MATHER, South Yorkshire (GB); David WELCH, Kent (GB); Rishi RUPARELIA, Greater London (GB); Graeme DUNN, Nottinghamshire (GB)

(21) Appl. No.: 18/015,175

(22) PCT Filed: Jun. 29, 2021
(86) PCT No.: PCT/GB2021/051641

§ 371 Date: Jan. 9, 2023

(30) Foreign Application Priority Data
Jul. 10, 2020 (IN) 202011029421

(51) Int. Cl. B01D 53/14; B01D 53/96

(52) U.S. Cl. CPC B01D 53/1425; B01D 53/1475; B01D 53/96; B01D 2252/20431; B01D 2257/504

(57) ABSTRACT

The present invention relates to a method and a system for the removal of carbon dioxide (CO₂) from solvents. In particular, the present invention relates to a method and a system for the removal of carbon dioxide (CO₂) from carbon dioxide (CO₂) rich solvents.

### DESCRIPTION OF INVENTION

### Field of the Invention

The present invention relates to a method and a system for the removal of carbon dioxide (CO₂) from a flue gas stream with a solvent-based system. In particular, the present invention relates to a method and a system for the regeneration of solvents and removal of carbon dioxide (CO₂) from carbon dioxide (CO₂) rich solvent streams.

### Background of the Invention

Flue gases from power plants and other industrial activities include pollutants, for example greenhouse gases. One such greenhouse gas is CO₂. Emissions of CO₂ to the atmosphere from industrial activities are of increasing concern to society and are therefore becoming increasingly regulated.

To reduce the amount of CO₂ released into the atmosphere, CO₂ capture technology can be applied. The selective capture of CO₂ allows CO₂ to be reused or geographically sequestered.

CN107970743 A discloses a carbon dioxide separation method that uses a two-tower multi-stage absorption and desorption method. CN1079743 A discloses the use of low-grade heat to flash regenerate a semi-lean solvent. However, the use of low-grade heat as disclosed in CN1079743 A is insufficient to achieve the level of liquid solvent regeneration of the invention presented herein.

The CO₂ capture method of the present invention is directed to CO₂ capture from flue gases and industrial gases, e.g. emissions from plants that burn hydrocarbon fuel. The CO₂ capture methods of the present invention are also applicable to CO₂ capture from coal, gas and oil fired boilers, combined cycle power plants, coal gasification, hydrogen plants, biogas plants and waste to energy plants.

Known CO₂ capture technology can be divided into physical adsorbents and chemical absorbents (commonly referred to as carbon capture solvents).

The CO₂ capture methods of the present invention use a solvent (i.e. carbon capture solvents). The solvent removes CO₂ from one or more gas streams. The CO₂ in the gas streams selectively react with components in the solvent, resulting in CO₂ being removed from the gas phase and absorbed by the solvent to form a CO₂ rich solvent. The CO₂ rich solvent is then heated, CO₂ is released back into the gas phase and the CO₂ rich solvent is depleted of its CO₂ content, forming a CO₂ lean solvent. The CO₂ lean solvent is recycled within the system to capture additional CO₂.

FIG. 1 illustrates a block diagram 100 of a conventional method and system for capturing CO₂ from flue gases.

In the conventional method and system for capturing CO₂ from flue gases, CO₂ is separated from a mixture of gases using a solvent (initially a CO₂ lean solvent), which selectively reacts with the CO₂ (to form a CO₂ rich solvent). After the CO₂ has reacted with the solvent (CO₂ lean solvent), the solvent (CO₂ rich solvent) can be regenerated (to CO₂ lean solvent) using heat to release the CO₂ and regenerate the solvent for further CO₂ processing.

As shown in FIG. 1 (indicating a prior art method and system), a flue gas 101 containing CO₂ enters the system. The temperature of the flue gas 101 when entering the system is typically greater than 100° C. The flue gas 101 optionally passes through a booster fan 102. The booster fan 102 increases the pressure of flue gas 101 to compensate for the pressure drop through the system, thereby ensuring that the pressure of the resultant CO₂ lean flue gas (flue gas 107) is at the same pressure as flue gas 101.

The flue gas 101 passes through a direct contact cooler 103. In the direct contact cooler, the flue gas 101 is contacted with a recirculating loop of cool water 104 in a counter-current configuration. Through this contact, the flue gas 101 is cooled to a temperature of typically 40° C., forming flue gas 101a.

The flue gas 101a enters an absorber column 105, where the flue gas 101a is counter-currently contacted with a liquid solvent 106 (cool, CO₂ lean solvent). The flue gas 101a rises through the absorber column 105. The liquid solvent 106 (cool, CO₂ lean solvent) enters the absorber column 105 via a liquid distributor (not shown in FIG. 1) positioned at the top of the absorber column 105, and cascades down through the absorber column 105. The absorber column 105 contains packing to maximise the surface area to volume ratio. The active components in the liquid solvent 106 (cool, CO₂ lean solvent) react with the CO₂ in the flue gas 101a.

When the liquid solvent 106 (cool, CO₂ lean solvent) reaches the bottom of the absorber column 105, it is rich in CO₂ and forms liquid solvent 108 (cool, CO₂ rich solvent).

When the flue gas 101a reaches the top of absorber column 105, it is depleted of CO₂ and forms flue gas 107 (CO₂ lean). The flue gas 107 (CO₂ lean) is released from the top of the absorber column 105.

The liquid solvent 108 (cool, CO₂ rich solvent) is regenerated in regenerator 109 with high-grade heat, to reform liquid solvent 106 (cool, CO₂ lean solvent). The liquid solvent 108 (cool, CO₂ rich solvent) enters the regenerator 109 (high-grade heat) via a cross-over heat exchanger 110. In the cross-over heat exchanger 110, the liquid solvent 108 (cool, CO₂ rich solvent) is heated by a liquid solvent 111 (hot, CO₂ lean solvent) to form liquid solvent 112 (hot, CO₂ rich solvent).

The liquid solvent 112 (hot, CO₂ rich solvent) enters the top of the regenerator 109 (high-grade heat) and cascades down the regenerator 109 (high-grade heat). Inside the regenerator (high-grade heat), the liquid solvent 112 (hot, CO₂ rich solvent) is heated through contact with a vapour 114 (high-grade heat). Typically, the vapour 114 (high-grade heat) flows upwards through the regenerator 109 (high-grade heat), counter-current to the liquid solvent 112 (hot, CO₂ rich solvent). Upon heating, the reaction between the active components of the liquid solvent and CO₂ reverses, releasing CO₂ gas 115 and forming a liquid solvent 111 (hot, CO₂ lean solvent).

Gaseous CO₂ 115 leaves the top of the regenerator 109 (high-grade heat). Gaseous CO₂ 115 can be used in downstream processes.

The liquid solvent 111 (hot, CO₂ lean solvent) is fed into a reboiler 113 (high-grade heat). Within the reboiler 113 (high-grade heat), the liquid solvent 111 (hot, CO₂ lean solvent) is boiled resulting in formation of the vapour 114 (high-grade heat). The vapour 114 (high-grade heat) is used in the regenerator 109 (high-grade heat).

The liquid solvent 111 (hot, CO₂ lean solvent) passes into the cross-over heat exchanger 110 and is cooled through contact with the liquid solvent 108 (cool, CO₂ rich solvent) to form liquid solvent 106 (cool, CO₂ lean solvent). The freshly formed liquid solvent 106 (cool, CO₂ lean solvent) is now ready to repeat the absorption process again.

The liquid solvent 106 (cool, CO₂ lean solvent) may pass through an additional cooler (not shown) before entering the absorber column 105.

In typical CO₂ capture methods that use chemical absorbents, regeneration of the chemical absorbent requires a high amount of energy. Regeneration of the chemical absorbent is therefore one of the largest operating costs for capturing CO₂.

There is a need for a lower cost method of regenerating the absorbent (i.e. the liquid solvent) after the absorbent has become a CO₂ rich chemical absorbent.

### SUMMARY OF THE INVENTION

The ability to generate the necessary quantity and quality of the heat required to regenerate the chemical absorbent is important. In general, the higher the temperature of the heat generated, the more valuable the heat is. In typical CO₂ capture processes, the heat required to heat the CO₂ rich chemical absorbent (i.e. the CO₂ rich liquid solvent) is supplied in the form of any heating fluid such as a condensing steam, hot gases, hot water or thermal oil.

In typical CO₂ capture processes that use chemical absorbents, regeneration of the chemical absorbent requires a temperature of equal to or greater than 120° C. (high-grade heat). It is desirable to use lower-value, low-grade heat sources to the greatest extent possible to remove CO₂ from a CO₂ rich chemical absorbent, so that the regeneration method is as cost effective as possible.

The present invention provides a method and a system of removing CO₂ from a solvent (e.g. a method of forming a CO₂ lean chemical absorbent from a CO₂ rich chemical absorbent).

The present invention provides a method and a system of removing CO₂ from a solvent, wherein lower temperature heat sources (i.e. low-grade heat) are used to partially or wholly regenerate the lean chemical absorbent.

The present invention provides a method and a system of removing CO₂ from a solvent, wherein the high-grade heat (equal to or greater than 120° C.) is partially replaced with low-grade heat in the range of from 60 to less than 120° C. This advantageously reduces the high-grade heat required by from 30 to 50%, typically 50% (plus or minus 10%), and decreases the overall operating cost.

The present invention provides a method and system that typically comprises at least two regeneration sections. Typically, one regeneration section comprises a regenerator for low-grade heat, and the second regeneration section comprises a second regenerator for high-grade heat respectively. The regenerator (low-grade heat) produces a hot CO₂ semi-lean stream which is only partially depleted of CO₂.The second regeneration section (high-grade heat) produces a hot CO₂ lean stream, which is analogous to stream 111 in the conventional method and system for capturing CO₂ from flue gases.

The present invention provides a method and a system where heat is exchanged between liquid streams that are regenerated with both high-grade and low-grade heat. The heat exchange advantageously allows customisation of the system, which advantageously allows optimisation of the operating cost of the overall energy consumption.

Representative features of the present invention are set out in the following clauses, which stand alone or may be combined, in any combination, with one or more features disclosed in the text and/or figures of the specification.

The present invention is now described with reference to the following clauses:

1. A method for regenerating a solvent comprising carbon dioxide (CO₂), the method comprising:
providing a solvent comprising carbon dioxide (CO₂);
passing the solvent comprising carbon dioxide (CO₂) through a low-grade heat regenerator to form a carbon dioxide (CO₂) lean solvent; and,
passing the carbon dioxide (CO₂) lean solvent through a low-grade heat reboiler.

2. The method of clause 1, wherein the low-grade heat regenerator operates at a temperature in the range of from 60 to less than 120° C.

3. The method of clause 1 or clause 2, wherein the low-grade heat regenerator operates at a temperature in the range of: from 100 to 119° C.; or, from 100 to 115° C.

4. The method of any one of clauses 1 to 3, wherein the low-grade heat reboiler operates at a temperature in the range of from 60 to less than 120° C.

5. The method of any one of clauses 1 to 4, wherein the low-grade heat reboiler operates at a temperature in the range of: from 100 to 119° C.; or, from 100 to 115° C.

6. The method of any one of clauses 1 to 5, wherein the method further comprises:
passing the solvent comprising carbon dioxide (CO₂) through a high-grade heat regenerator to form a carbon dioxide (CO₂) lean solvent; and,
passing the carbon dioxide (CO₂) lean solvent through a high-grade heat reboiler.

7. The method of clause 6, wherein the high-grade heat regenerator operates at a temperature equal to or greater than 120° C.

8. The method of clause 6 or clause 7, wherein the high-grade heat regenerator operates at a temperature of from 120° C. to 140° C.

9. The method of any one of clauses 6 to 8, wherein the high-grade heat reboiler operates at a temperature equal to or greater than 120° C.

10. The method of any one of clauses 6 to 9, wherein the high-grade heat reboiler operates at a temperature of from 120° C. to 140° C.

11. The method of any one of clauses 6 to 10, wherein the low-grade heat regenerator, the low-grade heat reboiler, the high-grade heat regenerator and the high-grade heat reboiler are in fluid communication such that solvent comprising carbon dioxide (CO₂) passes between two, three or four of the components.

12. The method of clause 11, wherein solvent comprising carbon dioxide (CO₂) leaving the low-grade heat reboiler passes to the high-grade heat regenerator; optionally, through a cross-over heat exchanger.

13. The method of any one of clauses 6 to 10, wherein:
the low-grade heat regenerator and the low-grade heat reboiler are in fluid communication such that solvent comprising carbon dioxide (CO₂) passes between the low-grade heat regenerator and the low-grade heat reboiler;
the high-grade heat regenerator and the high-grade heat reboiler are in fluid communication such that solvent comprising carbon dioxide (CO₂) passes between the high-grade heat regenerator and the high-grade heat reboiler; and,
the low-grade heat regenerator and the low-grade heat reboiler are hydraulically independent with (not in fluid communication with), and thermally dependent with (in thermal communication with), the high-grade heat regenerator and the high-grade heat reboiler.

14. The method of any one of clauses 1 to 13, the method further comprising:
splitting the solvent comprising carbon dioxide (CO₂) into a first stream and a second stream;
passing the first stream through a low-grade heat regenerator and a low-grade heat reboiler; and,
passing the second stream through a high-grade heat regenerator and a high-grade heat reboiler.

15. The method of clause 14, wherein the first stream is hydraulically dependent with (in fluid communication with) and thermally dependent with (in thermal communication with) the second stream.

16. The method of clause 14, wherein the first stream is hydraulically independent with (not in fluid communication with) and thermally dependent with (in thermal communication with) the second stream.

17. The method of clause 14, wherein the first stream is hydraulically independent with (not in fluid communication with) and thermally independent with (not in thermal communication with) the second stream.

18. The method of any one of clauses 14 to 17, wherein the step of splitting the solvent comprising carbon dioxide (CO₂) into a first stream and a second stream comprises splitting the solvent comprising carbon dioxide (CO₂) (in % by weight (or % by volume); ratio first stream: second stream):
50:50 (plus or minus 10%); or,
from 10% to 30%: from 90% to 70%; or,
from 70% to 90%: from 30% to 10%; or,
20%:80% (plus or minus 10%); or,
25%:75% (plus or minus 10%); or,
80%:20% (plus or minus 10%); or,
75%:25% (plus or minus 10%).

19. The method of any one of clauses 1 to 18, wherein the low-grade heat regenerator and the high-grade heat regenerator are combined to form a single combined high-grade heat and low-grade heat regenerator.

20. The method of clause 19, wherein the combined low-grade heat and high-grade heat regenerator, the low-grade heat reboiler and the high-grade heat reboiler are in fluid communication such that solvent comprising carbon dioxide (CO₂) passes between two or three of the components.

21. The method of clause 19 or clause 20, wherein:
the combined low-grade heat and high-grade heat regenerator and the low-grade heat reboiler are in fluid communication such that solvent comprising carbon dioxide (CO₂) passes between the combined low-grade heat and high-grade heat regenerator and the low-grade heat reboiler; and/or,
the combined low-grade heat and high-grade heat regenerator and the high-grade heat reboiler are in fluid communication such that solvent comprising carbon dioxide (CO₂) passes between the combined low-grade heat and high-grade heat regenerator and the high-grade heat reboiler.

22. The method of any one of clause 19 to 21, wherein the low-grade heat reboiler is positioned part-way down the combined low-grade heat and high-grade heat regenerator.

23. The method of any one of clauses 1 to 22, wherein a gas which does not dissolve into or react with the solvent (optionally inert gases such as hydrogen or nitrogen) is introduced into the reboiler(s) and/or the regenerator(s) to reduce the temperature in the reboiler(s) and/or the regenerator(s), thereby enabling the use of low-grade heat exclusively, or low-grade heat in combination with high grade heat.

24. The method of any one of clauses 1 to 23, wherein the step of providing a solvent comprising carbon dioxide (CO₂) comprises providing a CO₂ rich solvent; optionally, a CO₂ rich solvent with a concentration of carbon dioxide of from 2 to 3.3 mol L⁻¹.

25. The method of any one of clauses 1 to 24, wherein the formed carbon dioxide (CO₂) lean solvent is a carbon dioxide (CO₂) lean solvent with a concentration of carbon dioxide from 0.0 to 0.7 mol L⁻¹.

26. The method of any one of clauses 1 to 25, wherein the step of providing a solvent comprising carbon dioxide (CO₂) further comprises:

contacting a flue gas with carbon dioxide (CO₂) lean solvent within one, two, three, four, five, six, seven, eight, nine or ten, or more, absorber columns, wherein the absorber column(s) is (are) in fluid communication with the low-grade heat regenerator and the low-grade heat reboiler.

27. The method of clause 26, wherein the absorber column(s) is (are) in fluid communication with the low-grade heat regenerator and the low-grade heat reboiler through a cross-over heat exchanger.

28. The method of clause 26 or clause 27, wherein the absorber column(s) is (are) in fluid communication with a high-grade heat regenerator and the high-grade heat reboiler through a cross-over heat exchanger.

29. The method of any one of clauses 1 to 28, wherein the solvent is an intensified solvent; optionally, an intensified solvent comprising a tertiary amine, a sterically hindered amine, a polyamine, a salt and water; optionally, wherein the solvent is CDRMax.

30. A system for regenerating a solvent comprising carbon dioxide (CO₂), the system comprising:
a low-grade heat regenerator; and
a low-grade heat reboiler,
wherein the low-grade heat regenerator and the low-grade heat reboiler are each independently configured to regenerate the carbon dioxide (CO₂) lean solvent at a temperature in the range of from 60 to less than 120° C. (or, from 100 to 119° C.; or, from 100 to 115° C.).

31. The system of clause 30, wherein the system further comprises:
a high-grade heat regenerator; and,
a high-grade heat reboiler;
wherein the high-grade heat regenerator and the high-grade heat reboiler are configured to regenerate the carbon dioxide (CO₂) lean solvent at a temperature of equal to or greater than 120° C.

32. The system of clause 31, wherein the high-grade heat regenerator operates at a temperature of from 120° C. to 140° C.

33. The system of clause 31 or clause 32, wherein the high-grade heat reboiler operates at a temperature of from 120° C. to 140° C.

34. The system of any one of clauses 30 to 33, wherein the low-grade heat regenerator and the high-grade heat regenerator are combined to form a single combined high-grade heat and low-grade heat regenerator.

35. The system of any one of clauses 30 to 34, wherein the low-grade heat regenerator, the low-grade heat reboiler, the high-grade heat regenerator, the high-grade heat reboiler and/or the combined high-grade heat and low-grade heat regenerator are in fluid communication such that, in use, solvent comprising carbon dioxide (CO₂) passes between two, three or four of the components.

36. The system of clause 35, wherein solvent comprising carbon dioxide (CO₂) leaving the low-grade heat reboiler passes to the high-grade heat regenerator; optionally, through a cross-over heat exchanger.

37. The system of any one of clauses 30 to 36, wherein:
the low-grade heat regenerator and the low-grade heat reboiler are in fluid communication such that solvent comprising carbon dioxide (CO₂) passes between the low-grade heat regenerator and the low-grade heat reboiler;
the high-grade heat regenerator and the high-grade heat reboiler are in fluid communication such that solvent comprising carbon dioxide (CO₂) passes between the high-grade heat regenerator and the high-grade heat reboiler; and,
the low-grade heat regenerator and the low-grade heat reboiler are hydraulically independent with (not in fluid communication with), and thermally dependent with (in thermal communication with), the high-grade heat regenerator and the high-grade heat reboiler.

38. The system of any one of clauses 30 to 37, the system further comprising:

a splitter for splitting the solvent comprising carbon dioxide (CO₂) into a first stream and a second stream, the splitter configured to permit:
passing the first stream through a low-grade heat regenerator and a low-grade heat reboiler; and,
passing the second stream through a high-grade heat regenerator and a high-grade heat reboiler.

39. The system of clause 38, wherein the first stream is hydraulically dependent with (in fluid communication with) and thermally dependent with (in thermal communication with) the second stream.

40. The system of clause 38, wherein the first stream is hydraulically independent with (not in fluid communication with) and thermally dependent with (in thermal communication with) the second stream.

41. The system of clause 38, wherein the first stream is hydraulically independent with (not in fluid communication with) and thermally independent with (not in thermal communication with) the second stream.

42. The system of any one of clauses 38 to 41, wherein the splitter is configured to split the solvent comprising carbon dioxide (CO₂) into a first stream and a second stream in the following ratios (in % by weight (or % by volume); ratio first stream: second stream):
50:50 (plus or minus 10%); or,
from 10% to 30%: from 90% to 70%; or,
from 70% to 90%: from 30% to 10%; or,
20%:80% (plus or minus 10%); or,
25%:75% (plus or minus 10%); or,
80%:20% (plus or minus 10%); or,
75%:25% (plus or minus 10%).

43. The system of clause 34, wherein:
the combined low-grade heat and high-grade heat regenerator and the low-grade heat reboiler are in fluid communication such that solvent comprising carbon dioxide (CO₂) passes between the combined low-grade heat and high-grade heat regenerator and the low-grade heat reboiler; and/or,
the combined low-grade heat and high-grade heat regenerator and the high-grade heat reboiler are in fluid communication such that solvent comprising carbon dioxide (CO₂) passes between the combined low-grade heat and high-grade heat regenerator and the high-grade heat reboiler.

44. The system of any one of clauses 30 to 43, wherein the system is configured to convert a CO₂ rich solvent to a CO₂ lean solvent; optionally, a CO₂ rich solvent with a concentration of carbon dioxide of from 2 to 3.3 mol L⁻ ¹; optionally, a carbon dioxide (CO₂) lean solvent with a concentration of carbon dioxide from 0.0 to 0.7 mol L⁻¹.

45. The system of any one of clauses 30 to 44, wherein the system further comprises:

one, two, three, four, five, six, seven, eight, nine or ten absorber columns, wherein the absorber column(s) is (are) in fluid communication with the low-grade heat regenerator and the low-grade heat reboiler.

46. The system of clause 45, wherein the absorber column(s) is (are) in fluid communication with the low-grade heat regenerator and the low-grade heat reboiler through a cross-over heat exchanger.

47. The system of clause 45 or clause 46, wherein the absorber column(s) is (are) in fluid communication with a high-grade heat regenerator and the high-grade heat reboiler through a cross-over heat exchanger.

48. The system of any one of clauses 45 to 47, wherein the absorber column(s) is (are) in fluid communication with a combined low-grade heat and high-grade heat regenerator, the low-grade heat reboiler and the high-grade heat reboiler through a cross-over heat exchanger.

49. The system of any one of clauses 30 to 48, wherein the system further comprises a gas which does not dissolve into or react with the solvent (optionally inert gases such as hydrogen or nitrogen), the gas being present in the reboiler(s) and/or the regenerator(s) to reduce the temperature in the reboiler(s) and/or the regenerator(s), thereby enabling the use of low-grade heat exclusively, or low-grade heat in combination with high grade heat.

50. The system of any one of clauses 30 to 49, wherein the system further comprises an intensified solvent; optionally, an intensified solvent comprising a tertiary amine, a sterically hindered amine, a polyamine, a salt and water; optionally, wherein the solvent is CDRMax.

The presently claimed methods and systems are typically applied to carbon capture processes and methods. However, the invention is not restricted to that particular use, but could be applied to any method requiring the removal of CO₂ components from an absorbent. The present invention is not restricted to the separation of a liquid and gas.

### BRIEF DESCRIPTION OF THE FIGURES

Embodiments of the invention are described below with reference to the accompanying drawings. The accompanying drawings illustrate various embodiments of systems, methods, and various other aspects of the disclosure. Any person of ordinary skill in the art will appreciate that the illustrated element boundaries (e.g. boxes, groups of boxes, or other shapes) in the figures represent one example of the boundaries. It may be that in some examples one element is designed as multiple elements or that multiple elements are designed as one element. In some examples, an element shown as an internal component of one element may be implemented as an external component in another and vice versa. The components in the figures are not necessarily to scale, emphasis instead being placed upon illustrating principles. Furthermore, elements may not be drawn to scale. Non-limiting and non-exhaustive descriptions are described with reference to the following drawings.

FIG. 1 is a schematic diagram of a conventional system 100 that is used to capture CO₂ from flue gases

FIG. 2 is a schematic diagram of a system 200 used to capture CO₂ from flue gases according to the present invention.

FIG. 3 is a schematic diagram of a system 300 used to capture CO₂ from flue gases according to the present invention, wherein two streams of the liquid solvent are hydraulically independent and heat is exchanged between the two streams of liquid solvent.

FIG. 4 is a schematic diagram of a system 400 used to capture CO₂ from flue gases according to the present invention, wherein the liquid solvent is split between a low-grade heat regenerator and a high-grade heat regenerator.

FIG. 5 is a schematic diagram of a system 500 used to capture CO₂ from flue gases according to the present invention, wherein two absorber columns and two regenerators are hydraulically and thermally independent.

FIG. 6 is a schematic diagram of a system 600 used to capture CO₂ from flue gases according to the present invention, wherein the liquid solvent passes through a single regenerator that uses low-grade and high-grade heat.

FIG. 7 is a schematic diagram of a system 700 used to capture CO₂ from flue gases according to the present invention, wherein the liquid solvent passes through a single regenerator that uses low-grade heat from a reboiler positioned part-way down the regenerator and high-grade heat from a reboiler positioned at the bottom of the regenerator.

FIG. 8 is a schematic diagram of a system 800 used to capture CO₂ from flue gases according to the present invention, wherein the liquid solvent passes through a single regenerator that uses low-grade heat, and hydrogen.

FIG. 9 is a graph comparing systems 100 and 200.

FIG. 10 is a graph comparing systems 100, 200 and 300.

FIG. 11 is a graph comparing systems 100, 200, 300 and 400.

FIG. 12 is a graph comparing systems 100, 200, 300, 400 and 500.

FIG. 13 is a graph comparing the removal rate of CO₂ from a gas stream containing 15 vol.% CO₂ (dry basis, i.e. the presence of water is excluded for the purposes of the calculation) by a liquid solvent simulated as a function of heat at 120° C., 105° C. and 90° C.

FIG. 14 is a graph comparing the removal rate of CO₂ from a gas stream containing 9 vol.% CO₂ (dry basis, i.e. the presence of water is excluded for the purposes of the calculation) by a liquid solvent simulated as a function of heat at 120° C., 105° C. and 90° C.

FIG. 15 is a graph comparing the removal rate of CO₂ from a gas stream containing 5 vol.% CO₂ (dry basis, i.e. the presence of water is excluded for the purposes of the calculation) by a liquid solvent simulated as a function of heat at 120° C., 105° C. and 90° C.

### DETAILED DESCRIPTION OF THE INVENTION

Some embodiments of this disclosure will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the preferred systems and methods are now described.

Embodiments of the present disclosure will be described more fully hereinafter with reference to the accompanying drawings in which like numerals represent like elements throughout the figures, and in which example embodiments are shown. Embodiments of the claims may, however, be embodied in many different forms and should not be construed as limited to the embodiments set forth herein. The examples set forth herein are non-limiting examples and are merely examples among other possible examples.

### Definitions

Some of the terms used to describe the present invention are set out below:

“Flue gas” is a gas exiting to the atmosphere via a pipe or channel that acts as an exhaust from a boiler, furnace or a similar environment, for example a flue gas may be the emissions from power plants and other industrial activities that burn hydrocarbon fuel such as coal, gas and oil fired power plants, combined cycle power plants, coal gasification, hydrogen plants, biogas plants and waste to energy plants.

“Liquid solvent” refers to an absorbent. The liquid solvent may be an intensified solvent. Optionally, the intensified solvent comprises a tertiary amine, a sterically hindered amine, a polyamine, a salt and water. Optionally, the tertiary amine in the intensified solvent is one or more of: N-methyldiethanolamine (MDEA) or Triethanolamine (TEA). Optionally, the sterically hindered amines in the intensified solvent are one or more of: 2-amino-2-ethyl-1,3-propanediol (AEPD), 2-amino-2-hydroxymethyl-1,3-propanediol (AHPD) or 2-amino-2-methyl-1-propanol (AMP). Optionally, the polyamine in the intensified solvent is one or more of: 2-piperazine-1-ethylamine (AEP) or 1-(2-hydroxyethyl)piperazine. Optionally, the salt in the intensified solvent is potassium carbonate. Optionally, water (for example, deionised water) is included in the solvent so that the solvent exhibits a single liquid phase. Optionally, the solvent is CDRMax as sold by Carbon Clean Solutions Limited. CDRMax, as sold by Carbon Clean Solutions Limited, has the following formulation: from 15 to 25 weight % 2-amino-2-methyl propanol (CAS number 124-68-5); from 15 to 25 weight % 1-(2-ethylamino)piperazine (CAS number 140-31-8); from 1 to 3 weight % 2-methylamino-2-methyl propanol (CAS number 27646-80-6); from 0.1 to 1 weight % potassium carbonate (584-529-3); and, the balance being deionised water (CAS number 7732-18-5).

“CO₂ lean solvent” refers to solvent with a relatively low concentration of carbon dioxide. In a carbon dioxide capture method, a CO₂ lean solvent for contact with flue gases typically has a concentration of carbon dioxide from 0.0 to 0.7 mol L⁻¹.

“CO₂ semi-lean solvent” refers to a solvent with a relatively medium concentration of carbon dioxide. In a carbon dioxide method, the CO₂ semi-lean solvent for contact with flue gases typically has a concentration of carbon dioxide of from greater than 0.7 to less than 2 mol L⁻¹.In the context of removing CO₂ from a flue gas, a CO₂ rich solvent becomes a CO₂ semi-lean solvent when CO₂ leaves the liquid solvent upon heating to partially regenerate the lean solvent.

“CO₂ semi-rich solvent” refers to a solvent with a relatively medium concentration of carbon dioxide. In a carbon dioxide capture method, the CO₂ semi-rich solvent for contact with flue gases typically has a concentration of carbon dioxide of from greater than 0.7 to less than 2 mol L⁻¹.In the context of removing CO₂ from a flue gas, a CO₂ lean liquid solvent becomes CO₂ semi-rich when CO₂ leaves the gas phase by reacting with active components of the liquid solvent.

“CO₂ rich solvent” refers to a solvent with a relatively high concentration of carbon dioxide. In a carbon dioxide capture method, the CO₂ rich solvent after contact with flue gases typically has a concentration of carbon dioxide of from 2 to 3.3 mol L⁻¹.

“Direct contact cooler” refers to a part of a system where the CO₂ rich flue gas is cooled. Typically, a CO₂ rich flue gas enters a direct contact cooler at a temperature of 100° C., and is cooled by a recirculating loop of cool water to a temperature of 40° C.

“Absorber column” refers to a part of a system where components of a solvent (CO₂ lean solvent) uptake CO₂ from the gaseous phase to the liquid phase to form a CO₂ rich solvent. An absorber column contains trays or packing (random or structured), which provides transfer area and intimate gas-liquid contact. The absorber column may be a static column or a Rotary Packed Bed (RPB). An absorber column typically functions, in use, for example at a pressure of from 1 bar to 30 bar.

“Static column” refers to a part of a system used in a separation method. It is a hollow column with internal mass transfer devices (e.g. trays, structured packing, random packing). A packing bed may be structured or random packing which may contain catalysts or adsorbents.

“Rotary Packed Bed (RPB)” refers to an absorber or a regenerator where the packing is housed in a rotatable disk (rather than in a static bed, as in a static column), which can be rotated at high speed to generate a high gravity centrifugal force within the RPB.

“Regenerator (low-grade heat)” or “low-grade heat regenerator” refers to a part of a system where heat (typically from heat vapour) is used to reverse the reaction between the liquid solvent and CO₂ to generate CO₂ and solvent (CO₂ lean solvent). A regenerator (low-grade heat) operates in a temperature range of typically: from 60 to less than 120° C.; or, from 100 to 119° C.; or, from 105 to 115° C. Regeneration of a liquid solvent may be partial. A regenerator (low-grade heat) may be a static column or a Rotary Packed Bed (RPB). A regenerator typically functions, in use, for example at a pressure of from 0.2 bar to 0.8 bar.

“Regenerator (high-grade heat)” or “high-grade heat regenerator” refers to a part of a system where heat typically from heat vapour is used to reverse the reaction between the liquid solvent and CO₂ to generate CO₂ and solvent (CO₂ lean solvent). A regenerator (high-grade heat) operates at a temperature range of typically: equal to or greater than 120° C.; or, from 120 to 135° C.; or, from 120 to 140° C. Regeneration of the liquid solvent may be partial. A regenerator (high-grade heat) may be a static column or a Rotary Packed Bed (RPB). A regenerator typically functions, in use, for example at a pressure of from 0.8 bar to 5 bar.

“Cross-over heat exchanger” refers to a part of the system where one liquid solvent is heated, whilst another liquid solvent is cooled, because the liquids are in thermal connection. For example, a liquid solvent (cool CO₂ rich solvent) can be heated from the heat of another liquid solvent (hot CO₂ lean solvent). A cross-over heat exchanger typically functions, in use, for example at a pressure of from 1 bar to 30 bar.

“Low-grade” and “low-grade heat” refers to a part of a system, or a step of a method, that operates at a temperature typically in the range of from 60 to less than 120° C.

“High-grade” and “high-grade heat” refers to a part of a system, or a step of a method, that operates at a temperature typically in the range of: equal to or greater than 120° C.; or, from 120° C. to 135° C.; of from 120° C. to 140° C.

“Cool” refers to a temperature typically in the range of from 20 to 60° C.

“Semi-hot” refers to a temperature typically in the range of from 60 to 110° C.

“Hot” refers to a temperature typically equal to or greater than 120° C.; typically, in the range of from 120 to 180° C.; or, from 120 to 140° C.

“Intensified solvent” refers to a solvent that can achieve a high CO₂ loading (optionally ≥ 3.0 mol/L) and forms a greater proportion of bicarbonate salts than carbamate salts. Examples of intensified solvents are included in US 2017/0274317 A1, the disclosure of which is incorporated herein by reference. An intensified solvent, in some embodiments, comprises: an alkanolamine, a reactive amine and a carbonate buffer.

“L/G” is the flow rate of solvent (given on a mass basis) relative to the flow rate of the flue gas (given on a mass basis).

“PSIG” or “psig” refers to the gauge pressure (i.e. measured pressure) relative to atmospheric pressure, measured in pounds per square inch. Ambient air pressure is measured as 0 psig. 1 psig = 6894.76 Pascal.

“Mol %” refers to the percentage of total moles of a particular component within a mixture of components.

“Weight %” refers to the percentage, by total weight, of a particular component within a mixture of components.

“Volume %” refers to the percentage, by total volume, of a particular component within a mixture of components.

“Specific reboiler duty” refers to the reboiler energy (expressed as the weight of 50 psig saturated steam condensed to liquid) required to regenerate a rich or semi-rich solvent stream into a lean or semi-lean solvent divided by the weight of CO₂ captured.

“Simulation” refers to a method simulated on software provided by Bryan Research named ProMax®. ProMax® is an industry standard software used to simulate, amongst other things, CO₂ capture methods and systems.

### EXAMPLES

### System 200: A System and Method of the Present Invention

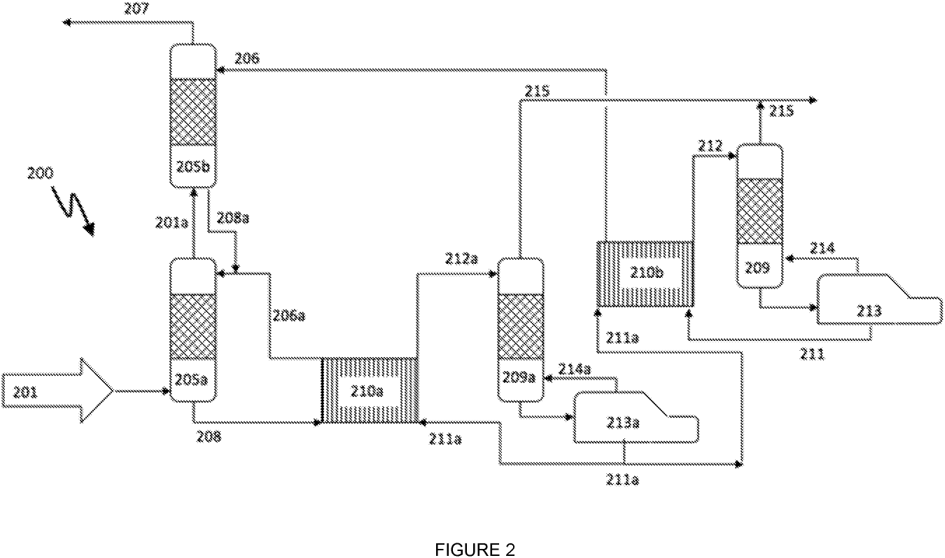

FIG. 2 is a schematic diagram of a system 200 used to capture CO₂ from flue gases according to the present invention.

A flue gas 201 containing CO₂ enters the system 200 at a temperature of typically 100° C.

Optionally, the flue gas 201 passes through a booster fan (not shown). The booster fan prevents the occurrence of, or compensates for, a pressure drop through the system.

Optionally, the CO₂ rich flue gas 201 enters a direct contact cooler (not shown). Optionally, the flue gas 201 enters the direct contact cooler after passing through the booster fan. The flue gas 201 contacts a recirculating loop of cool water in a counter-current configuration. Through contact with the recirculating loop of cool water, the flue gas 201 cools to a temperature of typically 40° C.

The flue gas 201 enters a first absorber column 205a. In the first absorber column 205a, the flue gas 201 comes into contact with a liquid solvent 206a (cool, CO₂ semi-lean solvent) and liquid solvent 208a (cool, CO₂ semi-rich solvent). Components within the solvents 206a and 208a selectively react with the CO₂ in the flue gas 201 resulting in the CO₂ transferring from the gas phase into the liquid phase.

The first absorber column 205a contains structured packing to maximise the surface area to volume ratio of the components within the solvents 206a and 208a. By maximising the surface area to volume ratio, the reaction between the CO₂ in the flue gas 201 and components in the solvents 206a and 208a is promoted.

The flue gas 201 enters at the bottom of the first absorber column 205a and rises through the first absorber column 205a, whilst solvents 206a and 208a enter the first absorber column 205a at the top and cascade through the first absorber column 205a to fall to the bottom of the first absorber column 205a under gravity. The flue gas 201 comes into contact with the solvents 206a and 208a in a counter-current configuration.

Upon reacting with the CO₂ in the flue gas 201, the solvents 206a and 208a become CO₂ rich and form liquid solvent 208 (cool, CO₂ rich solvent).

The use of both solvents 206a and 208a results in the flue gas 201 being partially depleted of its CO₂ content Flue gas 201a (CO₂ partially-depleted) is formed. Solvents 206a and 208a already have a CO₂ loading upon entering the first absorber column, and therefore the amount of CO₂ that the solvents can remove is reduced (compared to a CO₂ lean solvent).

Upon leaving the first absorber column 205a, the flue gas 201a (CO₂ partially-depleted) enters a second absorber column 205b. In the second absorber column 205b, the flue gas 201a (CO₂ partially-depleted) comes into contact with a liquid solvent 206 (cool, CO₂ lean solvent).

The second absorber column 205b contains structured packing to maximise the surface area to volume ratio of active components within the liquid solvent 206 (cool, CO₂ lean solvent). By maximising the surface area to volume ratio, the reaction between the CO₂ in the flue gas 201a (CO₂ partially-depleted) and components in the liquid solvent 206 (cool, CO₂ lean solvent) is promoted.

The flue gas 201a (CO₂ partially-depleted) enters at the bottom of the second absorber column 205b and rises through the second absorber column 205b, whilst liquid solvent 206 (cool, CO₂ lean solvent) enters the second absorber column 205b at the top and cascades through the second absorber column 205b. The flue gas 201a (CO₂ partially-depleted) comes into contact with the liquid solvent 206 (cool, CO₂ lean solvent) in a counter-current configuration.

Upon reacting with the CO₂ in the flue gas 201a (CO₂ partially-depleted), the liquid solvent 206 (cool, CO₂ lean solvent) becomes partially CO₂ rich and forms liquid solvent 208a (cool, CO₂ semi-rich solvent).

When the flue gas 201a (CO₂ partially-depleted) reaches the top of the second absorber column 205b, it is CO₂ lean (flue gas 207). The flue gas 207 (CO₂ lean) is released from the top of the second absorber column 205b. The flue gas 207 (CO₂ lean) contains typically from 30 to 90% less CO₂ (by weight) than flue gas 201, typically 85% less CO₂ (by weight) than flue gas 201.

The liquid solvent 208 (cool, CO₂ rich solvent) formed when solvents 206a and 208a react with CO₂, enters a first cross-over heat exchanger 210a. Inside the first cross-over heat exchanger 210a, the liquid solvent 208 (cool, CO₂ rich solvent) is heated using heat from a liquid solvent 211a (semi-hot, CO₂ semi-lean solvent). Upon heating, the liquid solvent 208 (cool, CO₂ rich solvent) forms liquid solvent 212a (semi-hot, CO₂ rich solvent).

The liquid solvent 212a (semi-hot, CO₂ rich solvent) is partially-regenerated in a regenerator 209a (low-grade heat). The liquid solvent 212a (semi-hot, CO₂ rich solvent) enters the top of the regenerator 209a (low-grade heat) and cascades through the regenerator 209a (low-grade heat) to the bottom under gravity. Inside the regenerator 209a (low-grade heat), the liquid solvent 212a (semi-hot, CO₂ rich solvent) is heated through contact with vapour 214a (low-grade heat).

Typically, the vapour 214a (low-grade heat) flows upwards through the regenerator 209a (low-grade heat), counter-current to the liquid solvent 212a (semi-hot, CO₂ rich solvent). The vapour 214a (low-grade heat) is typically at a temperature of from 60 to less than 120° C.

Upon heating, the reaction between the components of the solvent and CO₂ reverses and the liquid solvent is partially depleted of its CO₂ content and gaseous CO₂ 215 is formed.

Gaseous CO₂ 215 leaves the top of the regenerator 209a (low-grade heat). Gaseous CO₂ 215 can be used in downstream methods.

The liquid solvent passes into a reboiler 213a (low-grade heat), where it is heated to form liquid solvent 211a (semi-hot, CO₂ semi-lean solvent) and vapour 214a (low-grade heat).

The liquid solvent 211a (semi-hot, CO₂ semi-lean solvent) is split into separate streams. Typically, the liquid solvent 211a (semi-hot, CO₂ semi-lean solvent) is split into two streams.

The proportion of the split is determined by (a) the quality of heat supplied to the regenerator, (b) the value differential between the low-grade and high-grade heat sources and (c) the amount of CO₂ capture that is required.

One stream of the liquid solvent 211a (semi-hot, CO₂ semi-lean solvent) passes into the first cross-over heat exchanger 210a, where the liquid solvent 211a (semi-hot, CO₂ semi-lean solvent) heats the incoming liquid solvent 208 (cool, CO₂ rich solvent). By heating the liquid solvent 208 (cool, CO₂ rich solvent), the liquid solvent 211a (semi-hot, CO₂ semi-lean solvent) is cooled and forms the liquid solvent 206a (cool, CO₂ semi-lean solvent). The liquid solvent 206a (cool, CO₂ semi-lean solvent) passes into the first absorber column 205a.

The liquid solvent 206a (cool CO₂ semi-lean solvent) may pass through an additional cooler before passing into the first absorber column 205a.

Another stream of the liquid solvent 211a (semi-hot, CO₂ semi-lean solvent) passes into a second cross over heat exchanger 210b, where the liquid solvent 211a (semi-hot, CO₂ semi-lean solvent) is heated by a liquid solvent 211 (hot, CO₂ lean solvent), which is generated in a regenerator 209 (high-grade heat). Upon heating, the liquid solvent 211a (semi-hot, CO₂ semi-lean solvent) forms the liquid solvent 212 (hot, CO₂ semi-lean solvent).

The liquid solvent 212 (hot, CO₂ semi-lean solvent) enters the top of regenerator 209 (high-grade heat) and cascades through the regenerator 209 (high-grade heat) to the bottom under gravity. Inside the regenerator 209 (high-grade heat), the liquid solvent 212 (hot, CO₂ semi-lean solvent) is heated through contact with a vapour 214 (high-grade heat).

Typically, the vapour 214 (high-grade heat) flows upwards through the regenerator 209 (high-grade heat), counter-current to the liquid solvent 212 (hot, CO₂ semi-lean solvent). The vapour 214 (high-grade heat) is typically at a temperature of from 120 to 135° C.

When the liquid solvent 212 (hot, CO₂ semi-lean solvent) is contacted by vapour 214 (high-grade heat), CO₂ is removed from the solvent more effectively than at the temperature operating range of the regenerator 209a (low-grade heat). The reaction between the components of the solvent and CO₂ reverses upon heating, and results in the generation of the liquid solvent depleted of its CO₂ content and gaseous CO₂ 215.

Gaseous CO₂ 215 leaves the top of the regenerator 209 (high-grade heat). Gaseous CO₂ 215 can be used in downstream methods.

Upon leaving the regenerator 209 (high-grade heat), the liquid solvent is heated in a reboiler 213 (high-grade heat). Heating the liquid solvent generates vapour 214 (high-grade heat) and a liquid solvent 211 (hot, CO₂ lean solvent).

The vapour 214 (high-grade heat) passes into the regenerator 209 (high-grade heat).

The liquid solvent 211 (hot, CO₂ lean solvent) enters the second cross-over heat exchanger 210b. Inside the second cross-over heat exchanger 210b, the liquid solvent 211 (hot, CO₂ lean solvent) is cooled by the incoming liquid solvent 211a (semi-hot, CO₂ semi-lean solvent), resulting in formation of the liquid solvent 206 (cool, CO₂ lean solvent). The liquid solvent 206 (cool, CO₂ lean solvent) passes to the second absorber column 205b.

The liquid solvent 206 (cool CO₂ lean solvent) may pass through an additional cooler before passing into the second absorber column 205b.

Compared to typical CO₂ capture methods, the configuration of the present invention (for example, the configuration described with reference to FIG. 2) advantageously splits the liquid solvent between at least two regenerators operating at least at two temperatures (one regenerator providing low-grade heat, the other regenerator providing high-grade heat).

The configuration of system 200 replaces a proportion of the high-grade heat (typically at a temperature range of from 120 to 135° C.) with low-grade heat in the temperature range of from 60 to less than 120° C.

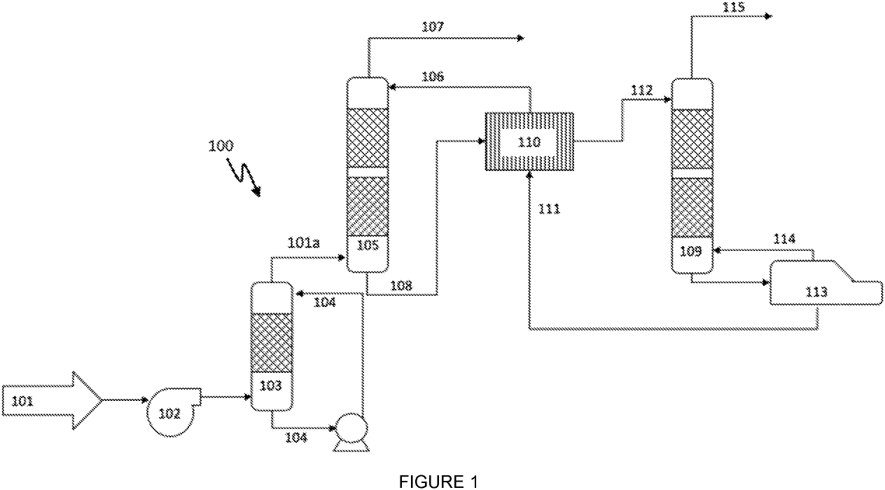

The configuration of system 200 reduces the high-grade heat required to regenerate the liquid solvent by from 20 to 35%, typically 35%, (compared to the system of FIG. 1, where only high-grade heat is used).

The configuration of system 200 mitigates the degradation of solvent components by reducing the required temperatures. This maximises the longevity of the solvents used in the system.

The configuration of system 200 reduces the operating cost by reducing the required duty of the more expensive high-grade heat.

The configuration of system 200 typically removes from 30 to 90% of the CO₂ (by weight) from the flue gas 201, or typically removes 85% of the CO₂ (by weight) from the flue gas 201. Higher and lower removal can be achieved by adjusting the process parameters.

### System 300: A System and Method of the Present Invention Where Two Streams of Liquid Solvent Remain Hydraulically Independent

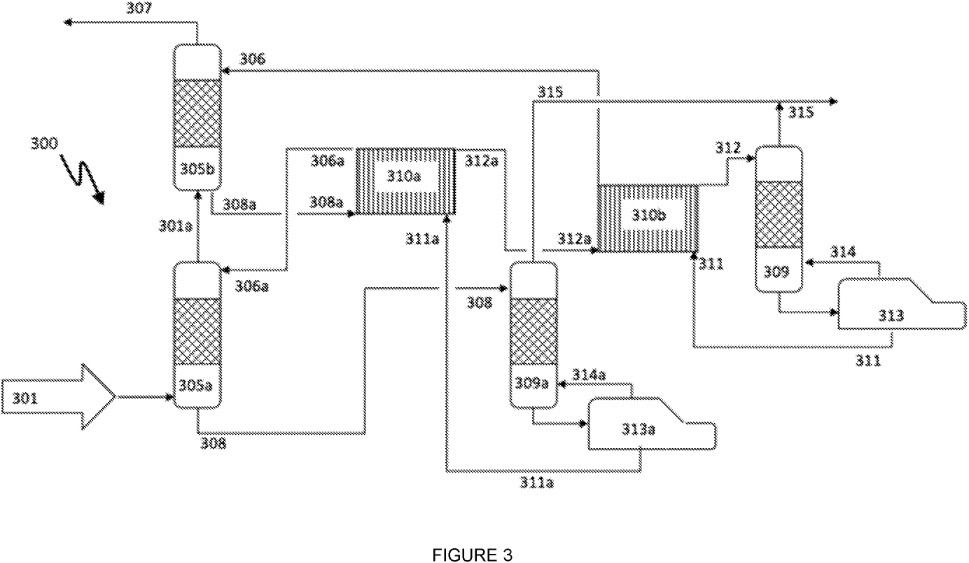

FIG. 3 is a schematic diagram of a system 300 used to capture CO₂ according to an example of the present invention.

In system 300, the liquid solvent is not mixed and split. Instead the liquid solvent is present in two hydraulically independent streams.

In system 300, a flue gas 301 containing CO₂ enters the system 300 at a temperature of 100° C. The flue gas 301 optionally passes through a booster fan and a direct contact cooler where it is cooled to a temperature of 40° C. (not shown).

In system 300, two absorber columns (305a and 305b) are used to remove CO₂ from the flue gas 301.

The flue gas 301 enters at the bottom of the first absorber column 305a and rises through the first absorber column 305a, whilst liquid solvent 306a enters the first absorber column 305a at the top and cascades under gravity through the first absorber column 305a. The flue gas 301 comes into contact with the liquid solvent 306a (cool, CO₂ semi-lean solvent) in a counter-current configuration. Components within the liquid solvent 306a selectively react with the CO₂ gas resulting in the CO₂ transferring from the gas phase into the liquid phase.

When the solvent 306a reaches the bottom of first absorber column 305a, the solvent is CO₂ rich and is now liquid solvent 308 (cool, CO₂ rich solvent).

Liquid solvent 308 (cool, CO₂ rich solvent) passes into a regenerator 309a (low-grade heat), where the reaction between the CO₂ and the liquid solvent is reversed by using vapour 314a (low-grade heat). Typically, the vapour 314a (low-grade heat) flows upwards through the regenerator 309a (low-grade heat), counter-current to the liquid solvent 308 (cool, CO₂ rich solvent). Gaseous CO₂ 315 is formed and leaves the top of the regenerator 309a (low-grade heat).

The liquid solvent 308 (cool, CO₂ rich solvent) then enters a reboiler 313a (low-grade heat), where it is heated. Upon heating, the vapour 314a (low-grade heat) and liquid solvent 311a (semi-hot, CO₂ semi-lean solvent) are formed. The vapour 314a (low-grade heat) is typically at a temperature of from 60 to less than 120° C.

The liquid solvent is depleted of its original CO₂ content by from 15 to 20% (by weight) and becomes stream 311a (semi-hot, CO₂ semi-lean solvent).

The liquid solvent 311a (semi-hot, CO₂ semi-lean solvent) enters a first cross-over heat exchanger 310a, where heat from the liquid solvent 311a (semi-hot, CO₂ semi-lean solvent) passes to the second solvent. Liquid solvent 306a (cool, CO₂ semi-lean solvent) is reformed and can begin the absorption process again.

The liquid solvent 306a (cool, CO₂ semi-lean solvent) may pass through an additional cooler before passing into the first absorber column 305a.

When the flue gas 301 reaches the top of first absorber column 305a, it has been partially depleted of its CO₂ content, and is now flue gas 301a (CO₂ partially-depleted).

In a second absorber column 305b, the flue gas 301a (CO₂ partially-depleted) comes into contact with a second solvent. The second solvent is in the form of a liquid solvent 306 (cool, CO₂ lean solvent). The flue gas 301a (CO₂ partially-depleted) enters at the bottom of the second absorber column 305b and rises through the second absorber column 305b, whilst liquid solvent 306 (cool, CO₂ lean solvent) enters the second absorber column 305b at the top and cascades under gravity through the second absorber column 305b. The flue gas 301a (CO₂ partially-depleted) comes into contact with the liquid solvent 306 (cool, CO₂ lean solvent) in a counter-current configuration. Components within the liquid solvent 306 (cool, CO₂ lean solvent) selectively react with the CO₂ gas resulting in the CO₂ transferring from the gas phase into the liquid phase.

When the liquid solvent 306 (cool, CO₂ lean solvent) reaches the bottom of the second absorber column 305b, liquid solvent 308a (cool, CO₂ semi-rich solvent) has formed.

Liquid solvent 308a (cool, CO₂ semi-rich solvent) enters the first cross-over heat exchanger 310a, where it is heated by heat from the first solvent. Liquid solvent 312a (semi-hot, CO₂ semi-rich solvent) is formed.

Liquid solvent 312a (semi-hot, CO₂ semi-rich solvent) passes into a second cross-over heat exchanger 310b, where the liquid solvent 312a (semi-hot, CO₂ semi-rich solvent) is heated by heat from a liquid solvent 311 (hot, CO₂ lean solvent) to form a liquid solvent 312 (hot, CO₂ semi-rich solvent).

The liquid solvent 312 (hot, CO₂ semi-rich solvent) passes into a regenerator 309 (high-grade heat), where the reaction between the CO₂ and the liquid solvent is reversed by using vapour 314 (high-grade heat). Typically, the vapour 314 (high-grade heat) flows upwards through the regenerator 309 (high-grade heat), counter-current to the liquid solvent 312 (hot, CO₂ semi-rich solvent). Gaseous CO₂ 315 is formed and leaves the top of the regenerator 309 (high-grade heat).

The liquid solvent enters reboiler 313 (high-grade heat), where it is heated. Upon heating, the vapour 314 (high-grade heat) and liquid solvent 311 (hot, CO₂ lean solvent) are formed. The vapour 314 (high-grade heat) is typically at a temperature of from 120 to 135° C.

The liquid solvent 311 (hot, CO₂ lean solvent) enters the second cross-over heat exchanger 310b, where heat is exchanged with liquid solvent 312a (semi-hot, CO₂ semi-rich solvent) to form liquid solvent 306 (cool, CO₂ lean solvent). Liquid solvent 306 (cool, CO₂ lean solvent) can begin the absorption process again.

The liquid solvent 306 (cool, CO₂ lean solvent) may pass through an additional cooler (not shown) before passing into the second absorber column 305b.

When the flue gas 301a (CO₂ partially-depleted) reaches the top of the second absorber column 305b, it is CO₂ lean (flue gas 307). The flue gas 307 (CO₂ lean) is released from the top of the second absorber column 305b.

The CO₂ stream generated in the regenerator 309 (high-grade heat) is combined with the CO₂ from the regenerator 309a (low-grade heat). Both CO₂ streams are mixed together and leave the method as a single stream. Gaseous CO₂ 315 may be used in downstream methods.

Compared to the typical CO₂ capture method, the configuration of system 300 advantageously splits the liquid solvent between at least two regenerators operating at least at two temperatures.

The configuration of system 300 replaces the high-grade heat (typically at a temperature range of from 120 to 135° C.) with low-grade heat that is typically in the temperature range of from 60 to less than 120° C.

The configuration of system 300 reduces the high-grade heat required by from 30 to 60%, typically by 60%.

The configuration of system 300 mitigates the degradation of solvent components by reducing the required temperatures.

The configuration of system 300 reduces the operating cost by reducing the required high-grade heat.

The configuration of system 300 is flexible with regard to shifting between the low-grade and high-grade heat sources for regeneration of the liquid solvent.

The configuration of system 300 typically removes from 30 to 90% of the CO₂ (by weight) from the flue gas 301, typically 85% of the CO₂ (by weight) from the flue gas 301. Higher and lower removal can be achieved by adjusting the process parameters.

### System 400: A System and Method of the Present Invention Wherein the Liquid Solvent is Split Between a Low-Grade and a High-Grade Heat Regenerator

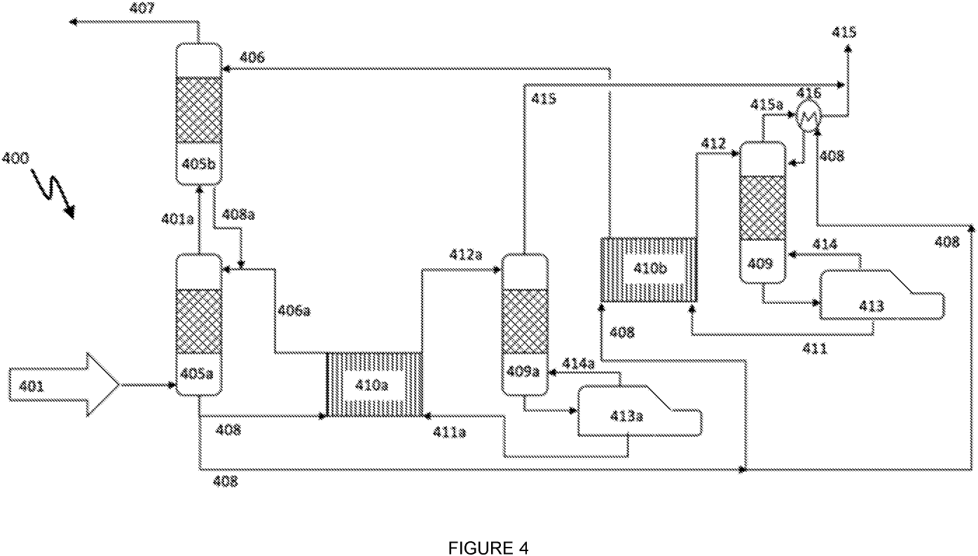

FIG. 4 is a schematic diagram of a system 400 used to capture CO₂ according to the present invention.

In system 400, the liquid solvent is split between low-grade and high-grade heat regenerators (409a and 409).

In system 400, a flue gas 401 containing CO₂ enters the system 400 at a temperature of typically 100° C. The flue gas 401 optionally passes through a booster fan and a direct contact cooler, where it is cooled to a temperature of typically 40° C.

In system 400, two absorber columns (405a and 405b) are used to remove CO₂ from the flue gas 401.

The flue gas 401 enters the first absorber column 405a. The first absorber column 405a contains structured packing to promote removal of CO₂ from the flue gas. In the first absorber column 405a, the flue gas 401 comes into contact with liquid solvent 406a (cool, CO₂ semi-lean solvent) and liquid solvent 408a (cool, CO₂ semi-rich solvent). Components within the solvents selectively react with the CO₂ gas, resulting in the CO₂ transferring from the gas phase into the liquid phase.

The flue gas 401 enters at the bottom of the first absorber column 405a and rise through the first absorber column 405a, whilst the liquid solvents 406a and 408a enter the first absorber column 405a at the top and cascade under gravity to the bottom of the first absorber column 405a. The flue gas 401 comes into contact with the solvents 406a and 408a in a counter-current configuration.

When the liquid solvents reach the bottom of first absorber column 405a, the solvents are CO₂ rich and are now liquid solvent 408 (cool, CO₂ rich solvent).

When the flue gas 401 reaches the top of first absorber column 405a, it has been partially depleted of its CO₂ content, and is now flue gas 401a (CO₂ partially-depleted).

In a second absorber column 405b, the flue gas 401a (CO₂ partially-depleted) comes into contact with a liquid solvent 406 (cool, CO₂ lean solvent). The second absorber column 405b contains structured packing to promote removal of CO₂ from the flue gas. The flue gas 401a (CO₂ partially-depleted) enters at the bottom of the second absorber column 405b and rises through the second absorber column 405b, whilst liquid solvent 406 (cool, CO₂ lean solvent) enters the second absorber column 405b at the top and cascades under gravity to the bottom of the second absorber column 405b.

Once the liquid solvent 406 (cool, CO₂ lean solvent) has reached the bottom of the second absorber column 405b, it has become CO₂ semi-rich. The liquid solvent has formed liquid solvent 408a (cool, CO₂ semi-rich solvent), which then enters the first absorber column 405a.

When the flue gas 401a (CO₂ partially-depleted) reaches the top of the second absorber column 405b, it is CO₂ lean (flue gas 407). The flue gas 407 (CO₂ lean) is released from the top of the second absorber column 405b.

Upon leaving the first absorber column 405a, the liquid solvent 408 (cool, CO₂ rich solvent) is split into two streams.

The proportion of the split is determined by (a) the quality of heat supplied to the regenerator, (b) the value differential between the low-grade and high-grade heat sources and (c) the amount of CO₂ capture that is required.

Typically, the liquid solvent 408 (cool, CO₂ rich solvent) is split into two streams in the ratio of from 20:80; or, from 25:75 (the ratios expressed in weight % or volume %) to form a first and a second stream respectively.

The first stream enters a first cross-over heat exchanger 410a, where it is heated by a liquid solvent 411a (semi-hot, CO₂ semi-lean solvent) to form liquid solvent 412a (semi-hot, CO₂ rich solvent).

The liquid solvent 412a (semi-hot, CO₂ rich solvent) enters a regenerator 409a (low-grade heat) and cascades under gravity over a packed bed to the bottom of the regenerator 409a (low-grade heat), whilst being contacted with vapour 414a (low-grade heat). The liquid solvent is partially regenerated and gaseous CO₂ 415 is generated.

Gaseous CO₂ 415 leaves the top of the regenerator 409a (low-grade heat). Gaseous CO₂ 415 may be used in downstream processes.

Upon reaching the bottom of the regenerator 409a (low-grade heat), the liquid solvent is drawn into a reboiler 413a (low-grade heat) where it is heated by low-grade heat. Upon heating, vapour 414a (low-grade heat) and liquid solvent 411a (semi-hot, CO₂ semi-lean solvent) are generated.

The vapour 414a (low-grade heat) is used in the regenerator 409a (low-grade heat). The vapour 414a (low-grade heat) is typically at a temperature of from 60 to less than 120° C.

The liquid solvent 411a (semi-hot, CO₂ semi-lean solvent) passes into the first cross-over heat exchanger 410a where it is cooled by incoming liquid solvent 408 (cool, CO₂ rich solvent). As a result of the cooling, liquid solvent 406a (cool, CO₂ semi-lean solvent) is reformed and can begin the absorption process again.

The liquid solvent 406a (cool, CO₂ semi-lean solvent) may pass through an additional cooler before passing into the first absorber column 405a.

The second stream is further split into two streams.

The proportion of the split is determined by (a) the quality of heat supplied to the regenerator (high-grade heat), and (b) the amount of CO₂ capture that is required.

Typically, the liquid solvent 408 (cool, CO₂ rich solvent) is split into two streams in the ratio of from 90:10; or, from 80:20 (the ratios expressed in weight % or volume %) to form a first and second, second stream respectively.

The first stream of the second stream is heated in a second cross-over heat exchanger 410b by a liquid solvent 411 (hot, CO₂ lean solvent) to form liquid solvent 412 (hot, CO₂ rich solvent).

The liquid solvent 412 (hot, CO₂ rich solvent) enters a regenerator 409 (high-grade heat) and cascades through a packed bed to the bottom of the regenerator 409 (high-grade heat), whilst being contacted with vapour 414 (high-grade heat). The liquid solvent is depleted of its CO₂ content and gaseous CO₂ 415a (hot) is formed.

The second stream of the second stream is heated by the gaseous CO₂415a (hot) in a condenser 416.

After heating the second stream, gaseous CO₂ 415 leaves the system. Gaseous CO₂ 415 can be used in downstream methods.

The second stream of the second stream then enters the regenerator 409 (high-grade heat) and cascades to the bottom of the regenerator 409 (high-grade heat), whilst being contacted with vapour 414 (high-grade heat). The liquid solvent is depleted of its CO₂ content and gaseous CO₂ 415a (hot) is formed.

At the bottom of the regenerator 409 (high-grade heat), the solvent is heated in a reboiler 413 (high-grade heat). Upon heating, vapour 414 (high-grade heat) and liquid solvent 411 (hot, CO₂ lean solvent) are generated.

The vapour 414 (high-grade heat) is used in the regenerator (high-grade heat). The vapour 414 (high-grade heat) is typically at a temperature of from 120 to 135° C.

The liquid solvent 411 (hot, CO₂ lean solvent) passes into the second cross-over heat exchanger 410b where it is cooled by incoming liquid solvent 408 (cool, CO₂ rich solvent). As a result of the cooling, liquid solvent 406 (cool, CO₂ lean solvent) is reformed and can begin the absorption process again.

The liquid solvent 406 (cool, CO₂ lean solvent) may pass through an additional cooler before passing into the second absorber column 405b.

Compared to the typical CO₂ capture method, the configuration of system 400 advantageously splits the liquid solvent between at least two regenerators operating at least at two temperatures.

The configuration of system 400 replaces the high-grade heat (typically at a temperature range of from 120 to 135° C.) with low-grade heat (typically at a temperature range of from 60 to less than 120° C.).

The configuration of system 400 reduces the high-grade heat required by from 20 to 35%, typically 35%.

The configuration of system 400 mitigates the degradation of solvent components by reducing the residence time of the solvent in the regenerator (high-grade heat).

The configuration of system 400 reduces the operating cost by reducing the required high-grade heat.

The configuration of system 400 minimises the proportion of liquid solvent that is regenerated with the regenerator 409a (low grade heat), and maximises the proportion of liquid solvent that is regenerated with the regenerator 409 (high grade heat).

The configuration of system 400 removes typically from 30 to 90 % (by weight) of the CO₂ from the flue gas 401, typically 85% (by weight) of the CO₂ from the flue gas 401. Higher and lower removal can be achieved by adjusting the process parameters.

### System 500: A System and Method of the Present Invention Wherein Two Absorber Columns and Two Regenerators are Hydraulically and Thermally Independent

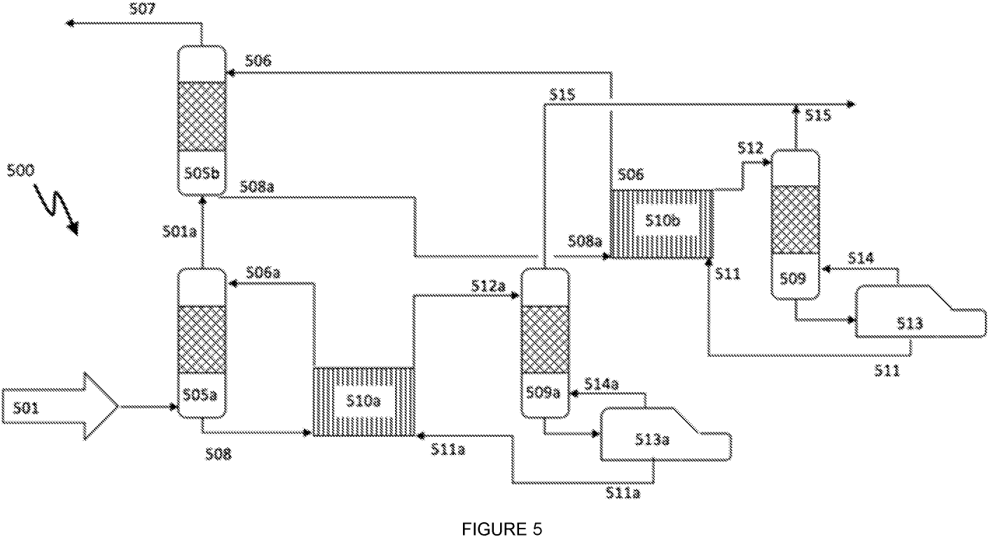

FIG. 5 is a schematic diagram of a system 500 used to capture CO₂ according to the present invention.

In system 500, two absorber columns (505a and 505b), two heat regenerators (509a and 509) and two solvent circuits which are hydraulically and thermally independent of one another.

The liquid solvent is split between each circuit in a 50:50 ratio, or 75:25 ratio (the ratios expressed in weight % or volume %) between the low-grade heat and high-grade heat circuits.

In a first liquid solvent circuit of system 500, the first absorber column 505a is used for partial removal of CO₂ from a flue gas 501. The flue gas 501 containing CO₂ enters the system 500 at a temperature of typically 100° C. The flue gas 501 optionally passes through a booster fan and a direct contact cooler, where it is cooled to a temperature of typically 40° C.

The flue gas 501 enters the first absorber column 505a. The flue gas 501 is contacted with liquid solvent 506a (cool, CO₂ semi-lean solvent) in the first absorber column 505a to form liquid solvent 508 (cool, CO₂ rich solvent).

The liquid solvent 508 (cool, CO₂ rich solvent) enters a first cross-over heat exchanger 510a, where it is heated by heat from liquid solvent 511a (semi-hot, CO₂ semi-lean solvent). Liquid solvent 512a (semi-hot, CO₂ rich solvent) is formed.

Liquid solvent 512a (semi-hot, CO₂ rich solvent) passes into a regenerator 509a (low-grade heat), where the reaction between the CO₂ and the liquid solvent is reversed by using vapour 514a (low-grade heat), forming a liquid solvent partially depleted of CO₂ and gaseous CO₂ 515.

Gaseous CO₂ 515 leaves the top of the regenerator 509a (low-grade heat). Gaseous CO₂ 515 may be used in downstream processes.

The liquid solvent then enters a reboiler 513a (low-grade heat) where it is heated to form liquid solvent 511a (semi-hot, CO₂ semi-lean solvent). The vapour 514a (low-grade heat) is formed in the reboiler 513a (low-grade heat) and has a temperature from 60 to less than 120° C.

The liquid solvent 511a (semi-hot, CO₂ semi-lean solvent) enters the first cross-over heat exchanger 510a, where it is cooled by exchanging heat with liquid solvent 508 (cool, CO₂ rich solvent). Liquid solvent 506a (cool, CO₂ semi-lean solvent) is reformed and can begin the absorption process again.

The liquid solvent 506a (cool, CO₂ semi-lean solvent) may pass through an additional cooler before passing into the first absorber column 505a.

When the flue gas 501 reaches the top of first absorber column 505a, it has been partially depleted of its CO₂ content, and flue gas 501a (CO₂ partially-depleted) is formed.

In a second liquid solvent circuit of system 500, the flue gas 501a (CO₂ partially-depleted) is contacted with liquid solvent 506 (cool, CO₂ lean solvent) in a second absorber column 505b to form liquid solvent 508a (cool, CO₂ semi-rich solvent).

The liquid solvent 508a (cool, CO₂ semi-rich solvent) enters a second cross-over heat exchanger 510b, where it is heated by heat from liquid solvent 511 (hot, CO₂ lean solvent). Liquid solvent 512 (hot, CO₂ semi-rich solvent) is formed.

Liquid solvent 512 (hot, CO₂ semi-rich solvent) passes into a regenerator 509 (high-grade heat), where the reaction between the CO₂ and liquid solvent is reversed by using vapour 514 (high-grade heat). Typically, the vapour 514 (high-grade heat) flows upwards through the regenerator 509 (high-grade heat), counter-current to the liquid solvent 512 (hot, CO₂ semi-rich solvent). Gaseous CO₂ 515 is formed and leaves the top of the regenerator 509 (high-grade heat).

Gaseous CO₂ 515 leaves the top of the regenerator 509 (high-grade heat). Gaseous CO₂ 515 may be used in downstream methods.

The liquid solvent then enters a reboiler 513 (high-grade heat) where it is heated. Upon heating, the vapour 514 (high-grade heat) and liquid solvent 511 (hot, CO₂ lean solvent) are formed. The vapour 514 (high-grade heat) is typically at a temperature of from 120 to 135° C.

The liquid solvent 511 (hot, CO₂ lean solvent) enters the second cross-over heat exchanger 510b, where it is cooled by liquid solvent 508a (cool, CO₂ semi-rich solvent). Liquid solvent 506 (cool, CO₂ lean solvent) is reformed and can begin the absorption process again.

The liquid solvent 506 (cool, CO₂ lean solvent) may pass through an additional cooler before passing into the second absorber column 405b.

When the flue gas 501a (CO₂ partially-depleted) reaches the top of the second absorber column 505b, it is depleted of CO₂ and flue gas stream 507 is formed (CO₂ depleted). The flue gas 507 (CO₂ depleted) is released from the top of the second absorber column 505b.

Compared to typical CO₂ capture method, the configuration of system 500 advantageously splits the liquid solvent between at least two regenerators operating at least at two temperatures.

The configuration of system 500 replaces the high-grade heat (typically at a temperature range of from 120 to 135° C.) with low-grade heat that is in the temperature range of from 60 to less than 120° C.

The configuration of system 500 reduces the high-grade heat required by 40 to 50%.

The configuration of system 500 mitigates the degradation of solvent components by reducing the residence time of the solvent in the regenerator (high-grade heat).

The configuration of system 500 reduces the operating cost by reducing the required high-grade heat requirement.

The configuration of system 500 typically splits the liquid solvent into two equal streams, which reduces the high-grade heat regenerator being used heavily. Optionally, the split is 75:25 (the ratios expressed in weight % or volume %) between the low-grade heat and high-grade heat circuits.

The configuration of system 500 removes typically from 30 to 90% of the CO₂ (by weight) from the flue gas 501, typically 85% the CO₂ (by weight) from the flue gas 501. Higher and lower removal can be achieved by adjusting the process parameters.

The following are non-limiting examples that discuss, with reference to the graphs in certain figures, the advantages of using the system and method of the present invention.

### System 600: A System and Method of the Present Invention Wherein a Single Regenerator Uses Two Parallel Reboilers and a Single Absorber Column

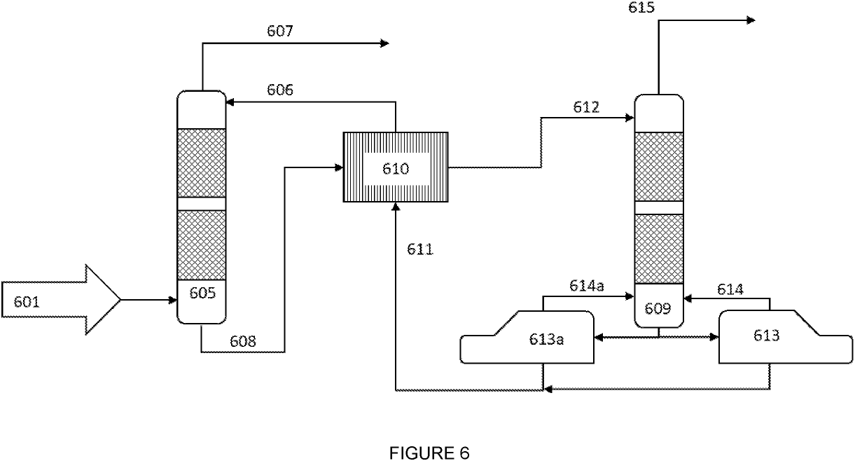

FIG. 6 is a schematic diagram of a system 600 used to capture CO₂ from flue gases according to the present invention.

In system 600, a flue gas 601 containing CO₂ enters the system 600 at a temperature of typically 100° C. The flue gas 601 optionally passes through a booster fan and a direct contact cooler (not shown), where it is cooled to a temperature of typically 40° C.

The flue gas 601 enters an absorber column 605, where the flue gas 601 is counter-currently contacted with a liquid solvent 606 (cool, CO₂ lean solvent). The flue gas 601 rises through the absorber column 605. The liquid solvent 606 (cool, CO₂ lean solvent) enters the absorber column 605 via a liquid distributor (not shown in FIG. 6) positioned at the top of the absorber column 605, and cascades down through the absorber column 605. The absorber column 605 contains packing to maximise the surface area to volume ratio. Components in the liquid solvent 606 (cool, CO₂ lean solvent) react with the CO₂ in the CO₂ rich flue gas 601.

Upon reacting with the CO₂ in the CO₂ rich flue gas 601, the liquid solvent 606 (cool, CO₂ lean solvent) becomes CO₂ rich and forms liquid solvent 608 (cool, CO₂ rich solvent).

When the flue gas 601 reaches the top of the absorber column 605, it is depleted of CO₂ and forms flue gas 607 (CO₂ lean). The flue gas 607 (CO₂ lean) is released from the top of the absorber column 605.

The liquid solvent 608 (cool, CO₂ rich solvent) is regenerated in regenerator 609 (low-grade and high-grade heat) with both low-grade heat and high-grade heat, to reform liquid solvent 606 (cool, CO₂ lean solvent).

The liquid solvent 608 (cool, CO₂ rich solvent) enters the regenerator 609 (low-grade and high-grade heat) via a cross-over heat exchanger 610. In the cross-over heat exchanger 610, the liquid solvent 608 (cool, CO₂ rich solvent) is heated by a liquid solvent 611 (hot, CO₂ lean solvent) to form liquid solvent 612 (hot, CO₂ rich solvent).

The liquid solvent 612 (hot, CO₂ rich solvent) enters the top of the regenerator 609 (low-grade and high-grade heat) and cascades down the regenerator 609 (low-grade and high-grade heat). Inside the regenerator 609 (low-grade and high-grade heat), the liquid solvent 612 (hot, CO₂ rich solvent) is heated through contact with vapour 614 (high-grade heat) and vapour 614a (low-grade heat). Typically, the vapour 614 (high-grade heat) and vapour 614a (low-grade heat) flow upwards through the regenerator 609 (low-grade and high-grade heat), counter-current to the liquid solvent 612 (hot, CO₂ rich solvent). The vapour 614a (low-grade heat) is typically at a temperature of from 60° C. to less than 120° C., and the vapour 614 (high-grade heat) is typically at a temperature of from 120° C. to 135° C. Upon heating, the reaction between the active components of the liquid solvent and CO₂ reverses, releasing CO₂ gas 615 and forming a liquid solvent 611 (hot, CO₂ lean solvent).

Gaseous CO₂ 615 leaves the top of the regenerator 609 (low-grade heat). Gaseous CO₂ 615 can be used in downstream processes.

The liquid solvent 611 (hot, CO₂ lean solvent) is split and fed into two parallel reboilers, reboiler 613 (high-grade heat) and reboiler 613a (low-grade heat). The proportion of the split is determined by (a) the quality of heat supplied to the regenerator, (b) the value differential between the low-grade and high-grade heat sources and (c) the amount of CO₂ capture that is required. Within the reboiler 613 (high-grade heat), the liquid solvent 611 (hot, CO₂ lean solvent) is boiled resulting in formation of the vapour 614 (high-grade heat). Within the reboiler 613a (low-grade heat), the liquid solvent 611 (hot, CO₂ lean solvent) is boiled resulting in formation of the vapour 614a (low-grade heat).

The vapour 614 (high-grade heat) and vapour 614a (low-grade heat) are used in the regenerator 609 (low-grade and high-grade heat).

The liquid solvent 611 (hot, CO₂ lean solvent) passes into the cross-over heat exchanger 610 and is cooled through contact with the liquid solvent 608 (cool, CO₂ rich solvent) to form liquid solvent 606 (cool, CO₂ lean solvent). The freshly formed liquid solvent 606 (cool, CO₂ lean solvent) is now ready to repeat the absorption process again.

The liquid solvent 606 (cool, CO₂ lean solvent) may pass through an additional cooler (not shown) before entering the absorber column 605.

Compared to typical CO₂ capture methods, the configuration of the present invention (for example, the configuration described with reference to FIG. 6) advantageously makes use of low-grade heat in conjunction with high-grade heat, in a single regenerator column. The low-grade heat may be (but not limited to) low pressure steam, or process stream, such as from the downstream processing unit which converts CO₂ to a chemical product, such as methanol.

The configuration of system 600 replaces a proportion of the high-grade heat (typically at a temperature range of from 120 to 135° C.) with low-grade heat in the temperature range of from 60 to less than 120° C. If low-grade heat is not available for a period of time, it is possible to use only high-grade heat, to meet the total thermal duty of the regenerator 609 (low-grade and high grade heat). Similarly, it may be possible to operate only using low-grade heat without any high-grade heat.

The configuration of system 600 reduces the high-grade heat required to regenerate the liquid solvent by from 50 to 90%, typically 80%, (compared to the system of FIG. 1, where only high-grade heat is used).

The configuration of system 600 mitigates the degradation of solvent components by reducing the required temperatures. This maximises the longevity of the solvents used in the system.

The configuration of system 600 reduces the operating cost by reducing the required duty of the more expensive high-grade heat.

The configuration of system 600 typically removes from 30 to 90% of the CO₂ (by weight) from the CO₂ rich flue gas 601, or typically removes 85% of the CO₂ (by weight) from the CO₂ rich flue gas 601. Higher and lower removal can be achieved by adjusting the process parameters.

### System 700: A System and Method of the Present Invention Wherein a Single Regenerator Uses a Bottom Reboiler and a Side Reboiler and a Single Absorber Column

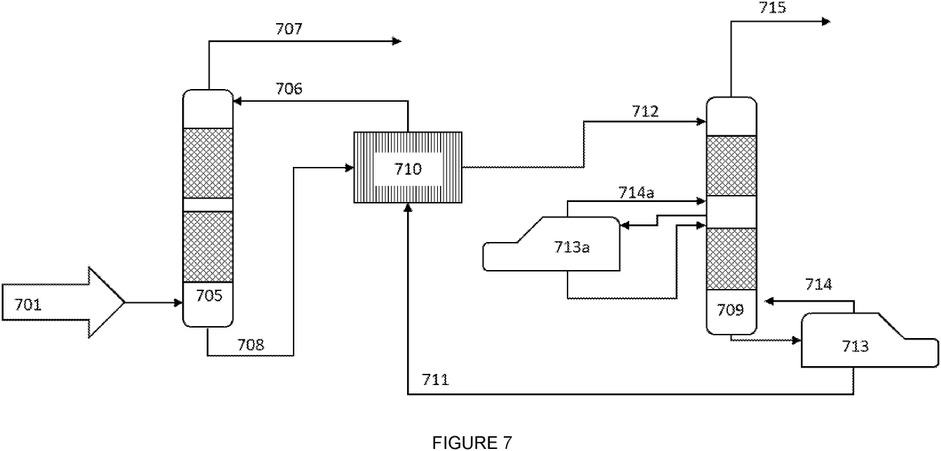

FIG. 7 is a schematic diagram of a system 700 used to capture CO₂ from flue gases according to the present invention.

In system 700, a flue gas 701 containing CO₂ enters the system 700 at a temperature of typically 100° C. The flue gas 701 optionally passes through a booster fan and a direct contact cooler (not shown), where it is cooled to a temperature of typically 40° C.

The flue gas 701 enters an absorber column 705, where the flue gas 701 is counter-currently contacted with a liquid solvent 706 (cool, CO₂ lean solvent). The flue gas 701 rises through the absorber column 705. The liquid solvent 706 (cool, CO₂ lean solvent) enters the absorber column 705 via a liquid distributor (not shown in FIG. 7) positioned at the top of the absorber column 705, and cascades down through the absorber column 705. The absorber column 705 contains packing to maximise the surface area to volume ratio. The active components in the liquid solvent 706 (cool, CO₂ lean solvent) react with the CO₂ in the flue gas 701.

When the liquid solvent 706 (cool, CO₂ lean solvent) reaches the bottom of the absorber column 705, it is rich in CO₂ and forms liquid solvent 708 (cool, CO₂ rich solvent).

When the flue gas 701 reaches the top of the absorber column 705, it is depleted of CO₂ and forms flue gas 707 (CO₂ lean). The flue gas 707 (CO₂ lean) is released from the top of the absorber column 705.

The liquid solvent 708 (cool, CO₂ rich solvent) is regenerated in regenerator 709 (low-grade and high grade heat) with both low-grade heat and high-grade heat, to reform liquid solvent 706 (cool, CO₂ lean solvent). The liquid solvent 708 (cool, CO₂ rich solvent) enters the regenerator 709 (low-grade heat) via a cross-over heat exchanger 710. In the cross-over heat exchanger 710, the liquid solvent 708 (cool, CO₂ rich solvent) is heated by a liquid solvent 711 (hot, CO₂ lean solvent) to form liquid solvent 712 (hot, CO₂ rich solvent).

The liquid solvent 712 (hot, CO₂ rich solvent) enters the top of the regenerator 709 (low-grade and high-grade heat) and cascades down the regenerator 709 (low-grade and high-grade heat). Inside the regenerator 709 (low-grade and high-grade heat), the liquid solvent 712 (hot, CO₂ rich solvent) is heated through contact with vapour 714 (high-grade heat) and vapour 714a (low-grade heat). Typically, the vapour 714 (high-grade heat) and vapour 714a (low-grade heat) flow upwards through the regenerator 709 (low-grade and high-grade heat), counter-current to the liquid solvent 712 (hot, CO₂ rich solvent). The vapour 714a (low-grade heat) is typically at a temperature of from 60° C. to less than 120° C., and the vapour 714 (high-grade heat) is typically at a temperature of from 120° C. to 135° C. Upon heating, the reaction between the active components of the liquid solvent and CO₂ reverses, releasing CO₂ gas 715 and forming a liquid solvent 711 (hot, CO₂ lean solvent).

Gaseous CO₂ 715 leaves the top of the regenerator 709 (low-grade and high-grade heat). Gaseous CO₂ 715 can be used in downstream processes.

At a position part-way down from the liquid solvent 712 (hot, CO₂ rich solvent) feed position to the regenerator 709 (low-grade and high-grade heat), a portion of the liquid solvent 712 (hot, CO₂ rich solvent) is taken as a side-draw and sent to reboiler 713a (low-grade heat). The quantity of side-draw liquid is determined by (a) the quality of heat supplied to the regenerator, (b) the value differential between the low-grade and high-grade heat sources and (c) the amount of CO₂ capture that is required. The portion of side-draw liquid could be from 0% to 100% of the liquid solvent 712 (hot, CO₂ rich solvent). Within the reboiler 713a (low-grade heat), the liquid solvent 711 (hot, CO₂ lean solvent) is boiled resulting in formation of the vapour 714a (low-grade heat).

The liquid solvent 711 (hot, CO₂ lean solvent) is fed to reboiler 713 (high-grade heat). The reboiler 713 (high-grade heat) is positioned towards the bottom of the regenerator 709 (low-grade and high-grade heat), preferably below the feed position for the reboiler 713a (low-grade heat). Within the reboiler 713 (high-grade heat), the liquid solvent 711 (hot, CO₂ lean solvent) is boiled resulting in formation of the vapour 714 (high-grade heat). The vapour 714 (high-grade heat) and vapour 714a (low-grade heat) are used in the regenerator 709 (low-grade heat).

The liquid solvent 711 (hot, CO₂ lean solvent) passes into the cross-over heat exchanger 710 and is cooled through contact with the liquid solvent 708 (cool, CO₂ rich solvent) to form liquid solvent 706 (cool, CO₂ lean solvent). The freshly formed liquid solvent 706 (cool, CO₂ lean solvent) is now ready to repeat the absorption process again.

The liquid solvent 706 (cool, CO₂ lean solvent) may pass through an additional cooler (not shown) before entering the absorber column 705.

Compared to typical CO₂ capture methods, the configuration of the present invention (for example, the configuration described with reference to FIG. 7) advantageously makes use of low-grade heat in conjunction with high-grade heat, in a single regenerator column. The low-grade heat may be (but not limited to) low pressure steam, or process stream, such as from the downstream processing unit which converts CO₂ to a chemical product, such as methanol.

The configuration of system 700 replaces a proportion of the high-grade heat (typically at a temperature range of from 120 to 135° C.) with low-grade heat in the temperature range of from 60° C. to less than 120° C. If low-grade heat is not available for a period of time, it is possible to use only high-grade heat, to meet the total thermal duty of the regenerator 709 (low-grade and high-grade heat).

The configuration of system 700 reduces the high-grade heat required to regenerate the liquid solvent by from 50 to 90%, typically 80%, (compared to the system of FIG. 1, where only high-grade heat is used).

The configuration of system 700 mitigates the degradation of solvent components by reducing the required temperatures. This maximises the longevity of the solvents used in the system.

The configuration of system 700 reduces the operating cost by reducing the required duty of the more expensive high-grade heat.

The configuration of system 700 typically removes from 30 to 90% of the CO₂ (by weight) from the flue gas 701, or typically removes 85% of the CO₂ (by weight) from the flue gas 701. Higher and lower removal can be achieved by adjusting the process parameters.

### System 800: A System and Method of the Present Invention Wherein a Single Regenerator Uses Hydrogen and a Single Absorber Column

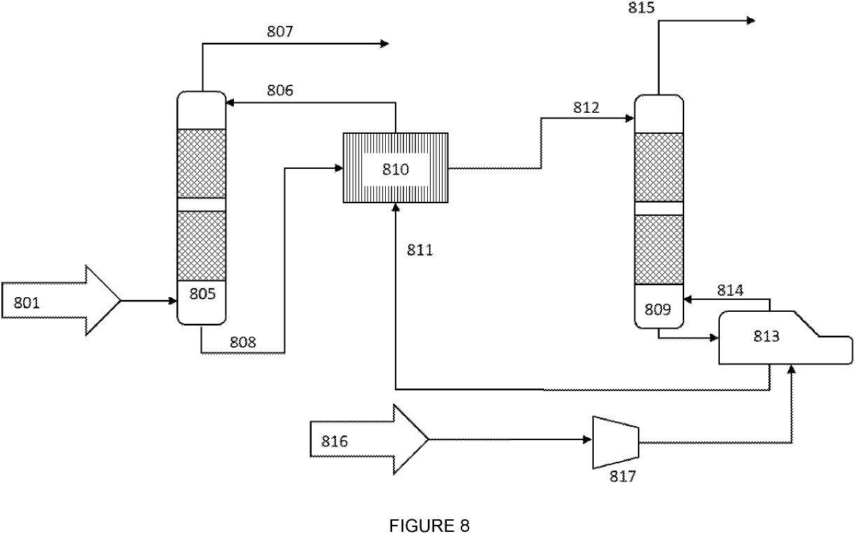

FIG. 8 is a schematic diagram of a system 800 used to capture CO₂ from flue gases according to the present invention.

In system 800, a flue gas 801 containing CO₂ enters the system 800 at a temperature of typically 100° C. The flue gas 801 optionally passes through a booster fan and a direct contact cooler, where it is cooled to a temperature of typically 40° C.

The flue gas 801 enters an absorber column 805, where the flue gas 801 is counter-currently contacted with a liquid solvent 806 (cool, CO₂ lean solvent). The flue gas 801 rises through the absorber column 805. The liquid solvent 806 (cool, CO₂ lean solvent) enters the absorber column 805 via a liquid distributor (not shown in FIG. 8) positioned at the top of the absorber column 805, and cascades down through the absorber column 805. The absorber column 805 contains packing to maximise the surface area to volume ratio. The active components in the liquid solvent 806 (cool, CO₂ lean solvent) react with the CO₂ in the flue gas 801.

When the liquid solvent 806 (cool, CO₂ lean solvent) reaches the bottom of the absorber column 805, it is rich in CO₂ and forms liquid solvent 808 (cool, CO₂ rich solvent).

When the flue gas 801 reaches the top of the absorber column 805, it is depleted of CO₂ and forms flue gas 807 (CO₂ lean). The flue gas 807 (CO₂ lean) is released from the top of the absorber column 805.

The liquid solvent 808 (cool, CO₂ rich solvent) is regenerated in regenerator 809 with low-grade heat, to reform liquid solvent 806 (cool, CO₂ lean solvent). The liquid solvent 808 (cool, CO₂ rich solvent) enters the regenerator 809 (low-grade heat) via a cross-over heat exchanger 810. In the cross-over heat exchanger 810, the liquid solvent 808 (cool, CO₂ rich solvent) is heated by a liquid solvent 811 (hot, CO₂ lean solvent) to form liquid solvent 812 (hot, CO₂ rich solvent).

The liquid solvent 812 (hot, CO₂ rich solvent) enters the top of the regenerator 809 (low-grade heat) and cascades down the regenerator 809 (low-grade heat). Inside the regenerator (low-grade heat), the liquid solvent 812 (hot, CO₂ rich solvent) is heated through contact with vapour 814 (low-grade heat). Typically, the vapour 814 (low-grade heat) flow upwards through the regenerator 809 (low-grade heat), counter-current to the liquid solvent 812 (hot, CO₂ rich solvent). The vapour 814 (low-grade heat) is typically at a temperature of from 60 to less than 120° C. Upon heating, the reaction between the active components of the liquid solvent and CO₂ reverses, releasing CO₂ gas 815 and forming a liquid solvent 811 (hot, CO₂ lean solvent).

Gaseous CO₂ 815 leaves the top of the regenerator 809 (low-grade heat). Gaseous CO₂ 815 can be used in downstream processes.

The liquid solvent 811 (hot, CO₂ lean solvent) is fed into reboiler 813 (low-grade heat). Depending on availability of low-grade heat, a second reboiler may be used using high-grade heat (not shown), in an arrangement similar to either FIG. 4 or FIG. 5. Within the reboiler 813 (low-grade heat), the liquid solvent 811 (hot, CO₂ lean solvent) is boiled resulting in formation of the vapour 814 (low-grade heat). The vapour 814 (low-grade heat) is used in the regenerator 809 (low-grade heat). Hydrogen gas 816 is fed into the reboiler 813 (low-grade heat) to aid vaporisation. The hydrogen gas 816 may also (or instead of) be fed directly to the regenerator 809 (low-grade heat). Depending on the pressure of hydrogen gas 816, a hydrogen compressor 817 may be required to boost the pressure to the operating pressure of the regenerator 809 (low-grade heat).

The liquid solvent 811 (hot, CO₂ lean solvent) passes into the cross-over heat exchanger 810 and is cooled through contact with the liquid solvent 808 (cool, CO₂ rich solvent) to form liquid solvent 806 (cool, CO₂ lean solvent). The freshly formed liquid solvent 806 (cool, CO₂ lean solvent) is now ready to repeat the absorption process again.

The liquid solvent 806 (cool, CO₂ lean solvent) may pass through an additional cooler (not shown) before entering the absorber column 805.

Compared to typical CO₂ capture methods, the configuration of the present invention (for example, the configuration described with reference to FIG. 8) advantageously makes use of hydrogen gas, in conjunction with low-grade heat, in a single regenerator column. The low-grade heat may be (but not limited to) low pressure steam, or process stream, such as from the downstream processing unit which converts CO₂ to a chemical product, such as methanol.

The configuration of system 800 uses hydrogen gas 816 to reduce the temperature of the fluids in the bottom of the regenerator 809 (low-grade heat). The ratio of molar flowrate of hydrogen gas 816 is up to 4 times the molar flowrate of gaseous CO₂ 815. In this way, it is possible to replace all of the high-grade heat (typically at a temperature range of from 120 to 135° C.) with low-grade heat in the temperature range of from 60 to less than 120° C. If low-grade heat is not available for a period of time, it is possible to use only high-grade heat, either in the reboiler 813 (low-grade heat), or in a separate reboiler using high-grade heat (not shown) to meet the total thermal duty of the regenerator 809 (low-grade heat).

The configuration of system 800 reduces the high-grade heat required to regenerate the liquid solvent by up to 100%, (compared to the system of FIG. 1, where only high-grade heat is used).

The configuration of system 800 mitigates the degradation of solvent components by reducing the required temperatures. This maximises the longevity of the solvents used in the system.

The configuration of system 800 reduces the operating cost by negating the use of the more expensive high-grade heat.

The configuration of system 800 typically removes from 30 to 90% of the CO₂ (by weight) from the flue gas 801, or typically removes 85% of the 8O₂ (by weight) from the flue gas 801. Higher and lower removal can be achieved by adjusting the process parameters.

### Example 1: A System and Method of the Present Invention (System 200) Compared with System 100

In one non-limiting example of the present invention, system 200 was compared with system 100.

In this non-limiting example of the present invention, CDRMax solvent was used (as sold by Carbon Clean Solutions Ltd) in systems 100 and 200.

In this non-limiting example of the present invention, systems 100 and 200 were set for 85% (by weight) CO₂ removal from a flue gas containing 5 mol % CO₂.

In this non-limiting example of the present invention, system 100 used a regenerator that operated using high-grade heat at a temperature of greater than 120° C.

Systems 100 and 200 regenerated 100% of the liquid solvent.

In this non-limiting example of the present invention, system 200 used two regenerators. One regenerator operated using low-grade heat at a temperature of 105° C., the second regenerator operated using high-grade heat at a temperature of 120° C.

In this non-limiting example of the present invention, 35% (by weight) of the liquid solvent passed through the regenerator operating at a temperature of 105° C., whilst 65% (by weight) of the liquid solvent passed through the regenerator operating at a temperature of 120° C. in system 200.

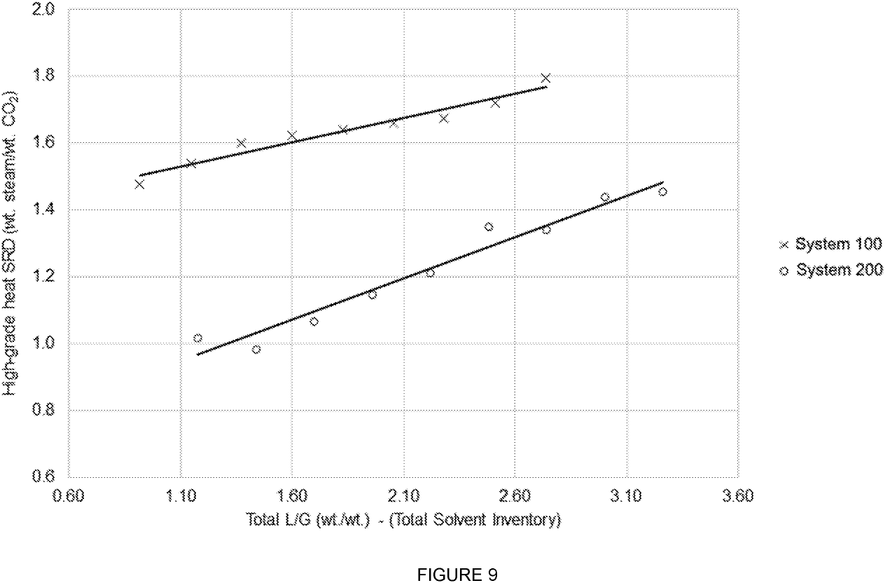

The results of this non-limiting example are plotted in FIG. 9. FIG. 9 plots the Specific Reboiler Duty (SRD) from high-grade heat usage in the regeneration of the CDRMax solvent as a function of L/G (by weight) of the total solvent inventory (both low-grade heat and high-grade heat regeneration) and flue gas.

FIG. 9 demonstrates that system 200 reduces reboiler (high-grade heat) duty by from 25 to 30%, at 85% (by weight) CO₂ removal from the liquid solvent, compared to system 100.

FIG. 9 demonstrates that system 200 removes CO₂ from liquid solvents, preferably when the liquid solvent has a high CO₂ concentration because more CO₂ will be removed from the liquid solvent by the low-grade heat relative to the liquid solvent that has a low CO₂ concentration.

### Example 2: A System and Method of the Present Invention Where Two Streams of Liquid Solvent Remain Hydraulically Independent (System 300) Compared to Systems 100 and 200

In one non-limiting example of the present invention, system 300 is compared with systems 100 and 200.

In this non-limiting example of the present invention, CDRMax was used in the simulation of systems 100, 200 and 300. The simulation was run on software provided by Bryan Research named ProMax®. ProMax® is an industry standard software used to simulate, amongst other things, CO₂ capture methods and systems.

Systems 100, 200 and 300 were set for 85% (by weight) CO₂ removal from a flue gas containing 5 mol % CO₂.

In this non-limiting example of the present invention, system 100 used a regenerator that operated using high-grade heat at a temperature of 120° C.

In this non-limiting example of the present invention, systems 200 and 300 used two regenerators. One regenerator operated using low-grade heat at a temperature of 105° C., the second regenerator operated using high-grade heat at a temperature of 120° C.

In this non-limiting example of the present invention, 35% (by weight) of the liquid solvent passed through the regenerator operating at a temperature of 105° C., whilst 65% (by weight) of the liquid solvent passed through the regenerator operating at a temperature of 120° C. in system 200.

In this non-limiting example of the present invention, two simulations of system 300 were created. The simulation was run on software provided by Bryan Research named ProMax®. ProMax® is an industry standard software used to simulate, amongst other things, CO₂ capture methods and systems.

In the first simulation, from 40 to 64% (by weight) of the liquid solvent passed through the regenerator operating at a temperature of 105° C., whilst from 36 to 60% (by weight) of the liquid solvent passed through the regenerator operating at a temperature of 120° C. In the second simulation, from 60 to 83% (by weight) of the liquid solvent passed through the regenerator operating at a temperature of 105° C., whilst from 17 to 40% (by weight) of the liquid solvent passed through the regenerator operating at a temperature of 120° C. The proportion of liquid solvent passing through each regenerator represents the percentage of the entire solvent inventory, because the two circuits of system 300 are hydraulically independent.

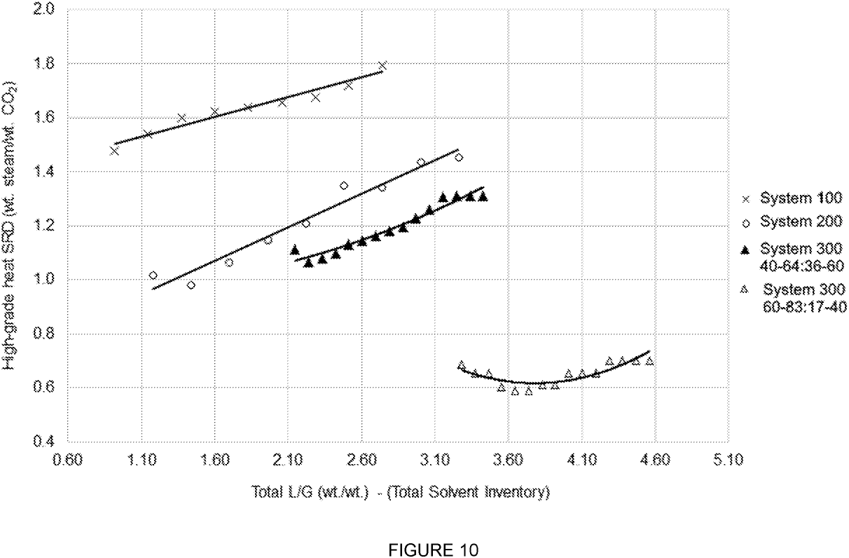

The results of this non-limiting example of the present invention are shown in FIG. 10. FIG. 10 compares systems 100, 200 and 300. FIG. 10 plots the Specific Reboiler Duty (SRD) from high-grade heat usage in the regeneration of the CDRMax solvent for systems 100, 200 and 300 as a function of L/G (by weight) of the total solvent inventory (both low-grade heat and high-grade heat regeneration) and flue gas.

FIG. 10 shows that when the liquid solvent in system 300 is split in the ratio of, from 40 to 64: from 36 to 60 (the ratios expressed in weight %), that passes through the regenerators operating at low-grade heat and high grade heat respectively, there is an improvement on the high-grade heat SRD relative to systems 100 and 200.

FIG. 10 shows that when the liquid solvent in system 300 is split in the ratio of, from 60 to 83: from 17 to 40, where the ratio can be by weight % or by volume %, that passes through the regenerators operating at low-grade heat and high-grade heat respectively, there is an improvement on the high-grade heat SRD relative to systems 100, 200 and system 300 split in the ratio of, from 40 to 64: from 36 to 60, where the ratio can be by weight % or by volume %.

FIG. 10 shows that system 300 allows the CO₂ loading of the liquid solvent to be independently optimised in the semi-lean and lean sections of system 300.

FIG. 10 shows that system 300 allows the flow rates of the liquid solvent to be independently optimised in the semi-lean and lean sections of system 300.

FIG. 10 shows that system 300 provides a single design, which provides the ability to shift between low-grade and high-grade heat through process changes only.

FIG. 10 shows that the combination of low-grade heat and heat integration in system 300 reduces the reboiler duty by 60%.

### Example 3: A System and Method of the Present Invention Wherein the Liquid Solvent is Split Between a Low-Grade and a High-Grade Heat Regenerator (System 400) Compared With Systems 100, 200 and 300

In one non-limiting example of the present invention, system 400 is compared with systems 100, 200 and 300.

In this non-limiting example of the present invention, CDRMax solvent was used in systems 100, 200, 300 and 400.

In this non-limiting example of the present invention, systems 100, 200, 300 and 400 were set for 85% (by weight) CO₂ removal from a flue gas containing 5 mol % CO₂.

In this non-limiting example of the present invention, system 100 used a regenerator that operated using high-grade heat at a temperature of 120° C.

In this non-limiting example of the present invention, systems 200, 300 and 400 used two regenerators. One regenerator operated using low-grade heat at a temperature of 105° C., the second regenerator operated using high-grade heat at a temperature of 120° C.

In this non-limiting example of the present invention, 35% (by weight) of the liquid solvent passed through the regenerator operating at a temperature of 105° C., whilst 65% (by weight) of the liquid solvent passed through the regenerator operating at a temperature of 120° C. in system 200.

In this non-limiting example of the present invention, from 60 to 83% (by weight) of the liquid solvent passed through the regenerator operating at a temperature of 105° C., whilst from 17 to 40% (by weight) of the liquid solvent passed through the regenerator operating at a temperature of 120° C. in system 300. The proportion of liquid solvent passing through each regenerator represents the percentage of the entire solvent inventory, because the two circuits of system 300 are hydraulically independent.

In this non-limiting example of the present invention, from 20 to 25% (by weight) of the liquid solvent passed through the regenerator operating at a temperature of 105° C., whilst from 75 to 80% (by weight) of the liquid solvent passed through the regenerator operating at a temperature of 120° C. in system 400. The low-grade heat solvent circuit is operating at capacity, with a constant solvent flow rate. The variation in the proportion of the low-grade heat regeneration comes from the variation of the high-grade heat regeneration circuit flow rate and hence the overall solvent flow rate.

In this non-limiting example of the present invention, the solvent streams are thermally independent of one another and therefore the high-grade heat integration is independent.

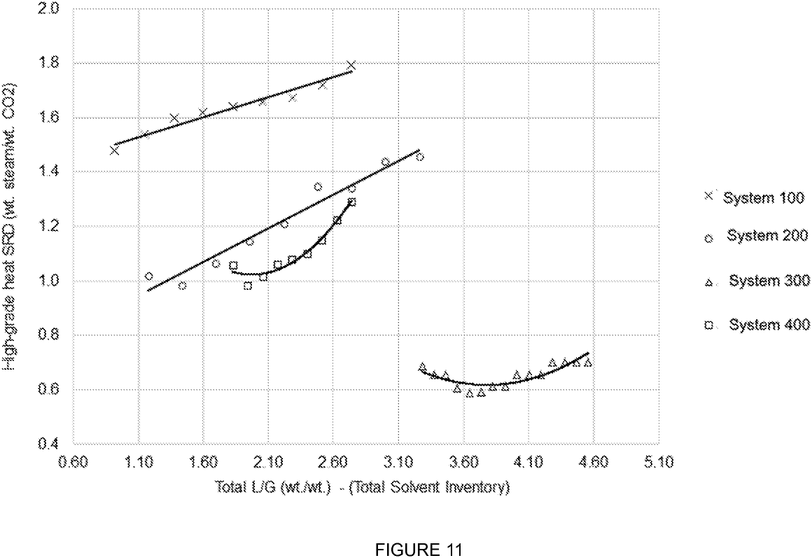

FIG. 11 compares systems 100, 200, 300 and 400. FIG. 11 plots the Specific Reboiler Duty (SRD) from high-grade heat usage in the regeneration of the CDRMax solvent for systems 100, 200, 300 and 400 as a function of L/G (by weight) of the total solvent inventory (both low-grade heat and high-grade heat regeneration) and flue gas.

FIG. 11 shows that system 400 reduces the high-grade heat SRD relative to systems 100 and 200.

### Example 4: A System And Method Of The Present Invention Wherein Two Absorber columns and Two Regenerators Are Hydraulically and Thermally Independent (System 500) Compared With Systems 100, 200, 300 And 400

In one non-limiting example of the present invention, system 500 is compared with systems 100, 200, 300 and 400.

In this non-limiting example of the present invention, CDRMax solvent was used in systems 100, 200, 300, 400 and 500.

In this non-limiting example of the present invention, systems 100, 200, 300, 400 and 500 were set for 85% (by weight) CO₂ removal from a flue gas containing 5 mol % CO₂.

In this non-limiting example of the present invention, system 100 used a regenerator that operated using high-grade heat at a temperature of 120° C.

In this non-limiting example of the present invention, systems 200, 300, 400 and 500 used two regenerators. One regenerator operated using low-grade heat at a temperature of 105° C., the second regenerator operated using high-grade heat at a temperature of 120° C.

In this non-limiting example of the present invention, 35% (by weight) of the liquid solvent passed through the regenerator operating at a temperature of 105° C., whilst 65% (by weight) of the liquid solvent passed through the regenerator operating at a temperature of 120° C. in system 200.

In this non-limiting example of the present invention, from 60 to 83% (by weight) of the liquid solvent passed through the regenerator operating at a temperature of 105° C., whilst from 17 to 40% (by weight) of the liquid solvent passed through the regenerator operating at a temperature of 120° C. in system 300. The proportion of liquid solvent passing through each regenerator represents the percentage of the entire solvent inventory, because the two circuits of system 300 are hydraulically independent.

In this non-limiting example of the present invention, from 20 to 25% (by weight) of the liquid solvent passed through the regenerator operating at a temperature of 105° C., whilst from 75 to 80% (by weight) of the liquid solvent passed through the regenerator operating at a temperature of 120° C. in system 400. The low-grade heat solvent circuit is operating at capacity, with a constant solvent flow rate. The variation in the proportion of the low-grade heat regeneration comes from the variation of the high-grade heat regeneration circuit flow rate and hence the overall solvent flow rate.

In this non-limiting example of the present invention, from 56 to 82% (by weight) of the liquid solvent passed through the regenerator operating at a temperature of 105° C., whilst from 18 to 44% (by weight) of the liquid solvent passed through the regenerator operating at a temperature of 120° C. in system 500. The proportion of liquid solvent passing through each regenerator represents the percentage of the entire solvent inventory, because the two circuits of system 500 are hydraulically independent.

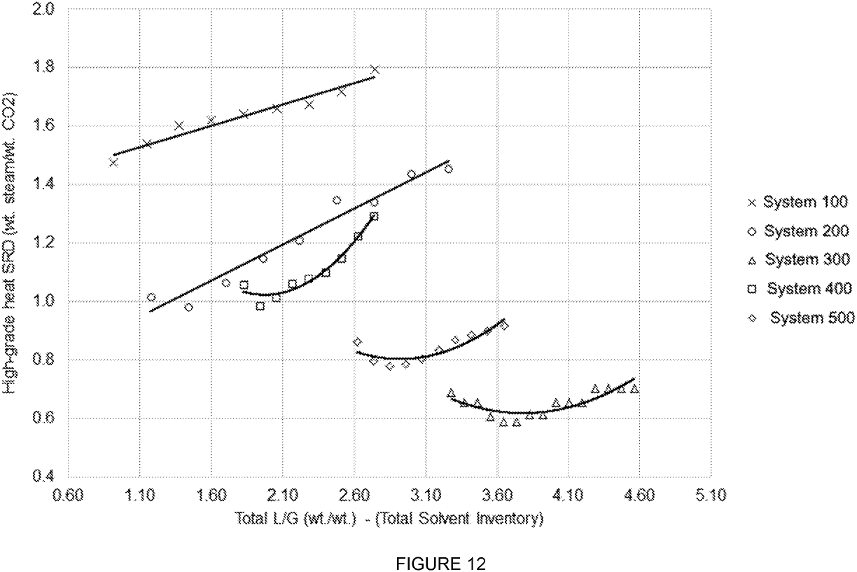

FIG. 12 compares systems 100, 200, 300, 400 and 500. FIG. 12 plots the Specific Reboiler Duty (SRD) from high-grade heat usage in the regeneration of the CDRMax solvent for systems 100, 200, 300, 400 and 500 as a function of L/G (by weight) of the total solvent inventory (both low-grade heat and high-grade heat regeneration) and flue gas.

FIG. 12 shows that system 500 reduces the high-grade heat SRD relative to system 100, whilst not using significantly more low-grade heat.

### Example 5: Removal Rate of CO₂ From a Flue Gases Containing Varying Amounts of CO₂ as a Function of the Ratio of Liquid Solvent Weight Rate to Gas Weight Rate

In one non-limiting example of the present invention, the removal rate of CO₂ from a flue gas was simulated as a function of the weight ratio of liquid to gas.

In this non-limiting example of the present invention, the system consisted of one regenerator operating at different temperature set points.

In this non-limiting example of the present invention, CDRMax solvent was used.

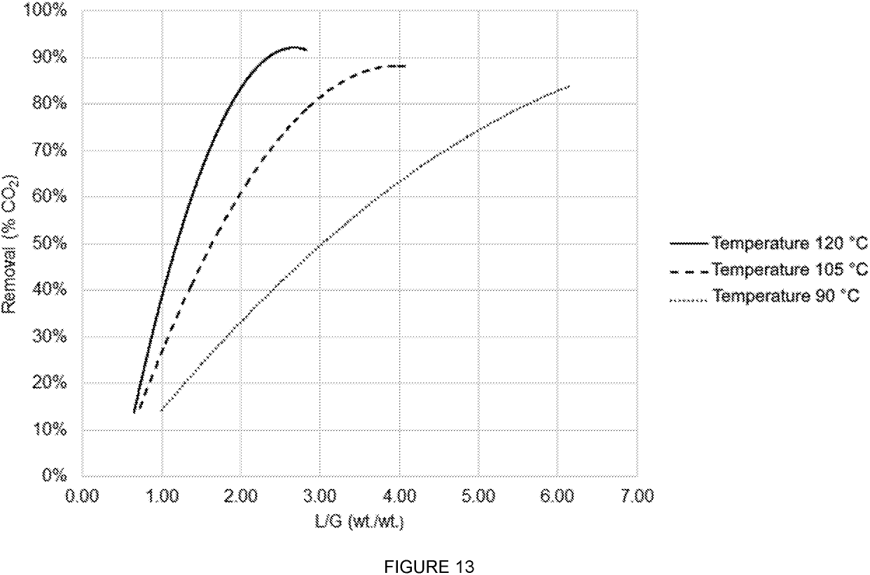

The results of this present invention are shown in FIGS. 13, 14 and 15. FIGS. 13, 14 and 15 are graphs showing the removal efficiency (% of CO₂ captured from the total CO₂ present in the flue gas) as a function of the liquid to gas ratio (L/G) and temperature of the heat used to regenerate the solvent.

In this non-limiting example, the temperature of the regenerator was changed three times to compare the effect of temperature on the removal rate of CO₂ from the flue gas.

In this non-limiting example, the temperature of the regenerator was simulated to be 120° C., 105° C. and 90° C.

It was found that the CO₂ loading of the liquid solvent after passing through the regenerator was limited by the regeneration temperature.

When the temperature of the regenerator was simulated to be 120° C., the CO₂ loading of the CO₂ lean liquid solvent was 0.16 mol L⁻¹. Whereas, when the temperature of the regenerator was simulated to be 105° C., the CO₂ loading of the CO₂-lean liquid solvent was 0.29 mol L⁻¹ and when the temperature of the regenerator was simulated to be 90° C., the CO₂ loading of the CO₂-lean liquid solvent was 0.45 mol L⁻¹.

### Comparison 1: 15 Mol% CO₂ Flue Gas

In this non-limiting example, the CO₂ concentration in the flue gas was set to 15 mol%.

In FIG. 13, CO₂ removal from a flue gas containing 15 mol% CO₂ was plotted as a function of L/G. As shown in FIG. 13, the use of a regenerator operating at low-grade heat temperatures results in capture efficiencies below 90% (capture efficiencies of 90% were achieved with the high-grade heat systems).

To achieve maximum removal, the L/G is increased in the low-grade heat regeneration systems (i.e. the CDRMax solvent flow rate is increased).

### Comparison 2: 9 Mol% CO₂ Flue Gas

In this non-limiting example, the CO₂ concentration in the flue gas was set to 9 mol%.

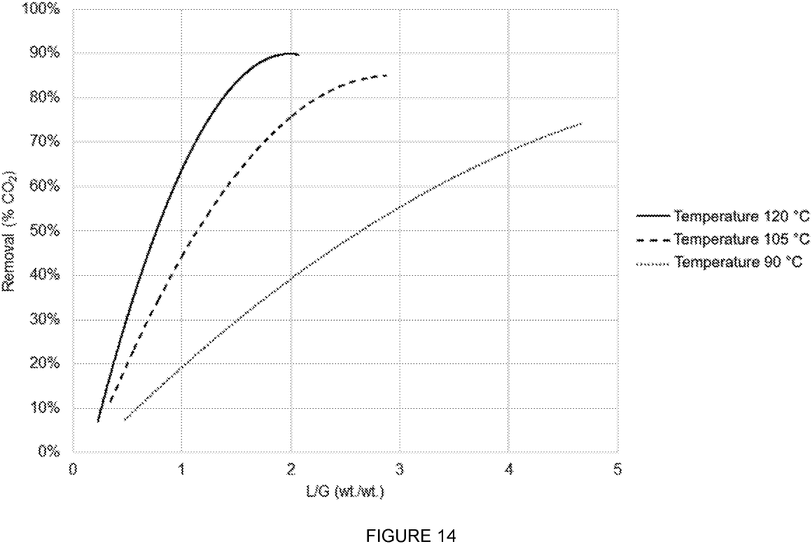

In FIG. 14, CO₂ removal from a flue gas containing 9 mol% CO₂ was plotted as a function of L/G. As shown in FIG. 14, the use of a regenerator operating at low-grade heat temperatures results in capture efficiencies below what can be achieved with high-grade heat regeneration. In this case, the 90° C. regeneration can only achieve about 75% (by weight) CO₂ removal from the flue gas.

To achieve maximum removal, the L/G is increased in the low-grade heat regeneration systems (i.e. the CDRMax solvent flow rate is increased).

### Comparison 3: 5 Mol% CO₂ Flue Gas

In this non-limiting example, the CO₂ concentration in the flue gas was set to 5 mol%.

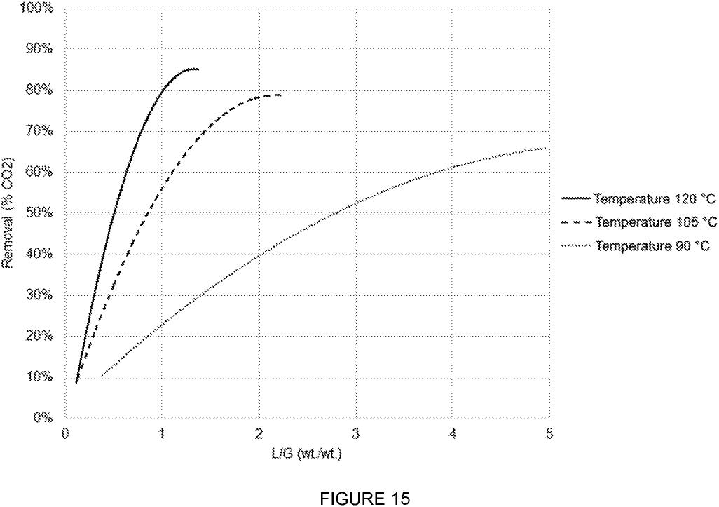

In FIG. 15, CO₂ removal from a flue gas containing 5 mol% CO₂ was plotted as a function of L/G. As shown in FIG. 15, the use of a regenerator operating at low-grade heat temperatures results in capture efficiencies below what can be achieved with high-grade heat regeneration. In this case, the 90° C. regeneration can only achieve about 65% (by weight) CO₂ removal from the flue gas.

To achieve maximum removal, the L/G is increased in the low-grade heat regeneration systems (i.e. the CDRMax solvent flow rate is increased).

### Comparison Conclusions

From FIGS. 13, 14 and 15, it can be seen that as the CO₂ concentration in the flue gas is reduced from 15 mol % to 5 mol %, the capture efficiency is decreased as the system is limited by the equilibrium concentration of the lean solution “lean pinch”.

For high-grade heat, the impact of the lean pinch is less prominent with approximately 85% (by weight) capture efficiency still obtainable with 5 mol% CO₂ flue gas.

For 105° C. and 90° C., the lean loadings of 0.29 mol L⁻¹ and 0.45 mol L⁻¹ (respectively) significantly limit the removal efficiency because of the equilibrium constraints. Low-grade heat alone cannot achieve the overall removal efficiency that is typically required by the industry.

The presently claimed invention combines low-grade heat and high-grade heat to meet the 85% (by weight) and greater removal efficiency typically required, and to reduce the overall requirement for high-grade heat. The presently claimed invention provides beneficial methods and systems which can be used to regenerate carbon dioxide lean solvents in carbon capture processes. The combination of low-grade heat and high-grade heat in the presently claimed methods and systems provides beneficial options to carbon capture plants. Previous methods and systems are limited in regenerating carbon dioxide lean solvents only with high-grade heat.

The use of a low-grade heat regenerator and a low-grade heat reboiler is particular applicable in waste-to-energy plants. Waste-to-energy plants provide energy and/or heating to cities. During summertime, there is ample high-grade heat available. However, during winter the availability of high-grade heat is limited due to internal processes used for heating and therefore the only available heat is low-grade heat. Utilising such low-grade heat in the methods and systems of the presently claimed invention is particularly beneficial.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A method for regenerating a solvent comprising carbon dioxide (CO₂), the method comprising:
providing a solvent comprising carbon dioxide (CO₂);
passing the solvent comprising carbon dioxide (CO₂) through a low-grade heat regenerator to form a carbon dioxide (CO₂) lean solvent, wherein the low-grade heat regenerator operates at a temperature in the range of from 60 to less than 120° C.; and,
passing the carbon dioxide (CO₂) lean solvent through a low-grade heat reboiler, wherein the low-grade heat reboiler operates at a temperature in the range of from 60 to less than 120° C.

2. (canceled)

3. The method of claim 1 wherein the low-grade heat regenerator operates at a temperature in the range of: from 100 to 119° C.; or, from 100 to 115° C.

4. (canceled)

5. The method of claim 1, wherein the low-grade heat reboiler operates at a temperature in the range of: from 100 to 119° C.; or, from 100 to 115° C.

6. The method of claim 1 wherein the method further comprises:
passing the solvent comprising carbon dioxide (CO₂) through a high-grade heat regenerator to form a carbon dioxide (CO₂) lean solvent; and,
passing the carbon dioxide (CO₂) lean solvent through a high-grade heat reboiler.

7. The method of claim 6, wherein the high-grade heat regenerator operates at a temperature equal to or greater than 120° C.

8. The method of claim 6 wherein the high-grade heat regenerator operates at a temperature of from 120° C. to 140° C., or
wherein the high-grade heat reboiler operates at a temperature equal to or greater than 120° C.; or
wherein the high-grade heat reboiler operates at a temperature of from 120° C. to 140° C.

9. (canceled)

10. (canceled)

11. The method of claim 6 wherein the low-grade heat regenerator, the low-grade heat reboiler, the high-grade heat regenerator and the high-grade heat reboiler are in fluid communication such that solvent comprising carbon dioxide (CO₂) passes between two, three or four of the components.

12. The method of claim 11, wherein solvent comprising carbon dioxide (CO₂) leaving the low-grade heat reboiler passes to the high-grade heat regenerator; optionally, through a cross-over heat exchanger.

13. The method of claim 6, wherein:
the low-grade heat regenerator and the low-grade heat reboiler are in fluid communication such that solvent comprising carbon dioxide (CO₂) passes between the low-grade heat regenerator and the low-grade heat reboiler;
the high-grade heat regenerator and the high-grade heat reboiler are in fluid communication such that solvent comprising carbon dioxide (CO₂) passes between the high-grade heat regenerator and the high-grade heat reboiler; and,
the low-grade heat regenerator and the low-grade heat reboiler are hydraulically independent with (not in fluid communication with), and thermally dependent with (in thermal communication with), the high-grade heat regenerator and the high-grade heat reboiler.

14. The method of claim 1, the method further comprising:
splitting the solvent comprising carbon dioxide (CO₂) into a first stream and a second stream;
passing the first stream through a low-grade heat regenerator and a low-grade heat reboiler; and,
passing the second stream through a high-grade heat regenerator and a high-grade heat reboiler.

15. The method of claim 14, wherein the first stream is hydraulically dependent with (in fluid communication with) and thermally dependent with (in thermal communication with) the second stream; or
wherein the first stream is hydraulically independent with (not in fluid communication with) and thermally dependent with (in thermal communication with) the second stream; or
wherein the first stream is hydraulically independent with (not in fluid communication with) and thermally independent with (not in thermal communication with) the second stream.

16. (canceled)

17. (canceled)

18. The method of claim 14, wherein the step of splitting the solvent comprising carbon dioxide (CO2) into a first stream and a second stream comprises splitting the solvent comprising carbon dioxide (CO2) (in % by weight (or % by volume); ratio first stream: second stream):
50:50 (plus or minus 10%); or,
from 10% to 30%: from 90% to 70%; or,
from 70% to 90%: from 30% to 10%; or,
20%:80% (plus or minus 10%); or,
25%:75% (plus or minus 10%); or,
80%:20% (plus or minus 10%); or,
75%:25% (plus or minus 10%).

19. The method of claim 1, wherein the low-grade heat regenerator and the high-grade heat regenerator are combined to form a single combined high-grade heat and low-grade heat regenerator.

20. The method of claim 19, wherein the combined low-grade heat and high-grade heat regenerator, the low-grade heat reboiler and the high-grade heat reboiler are in fluid communication such that solvent comprising carbon dioxide (CO₂) passes between two or three of the components.

21. The method of claim 19 wherein:
the combined low-grade heat and high-grade heat regenerator and the low-grade heat reboiler are in fluid communication such that solvent comprising carbon dioxide (CO₂) passes between the combined low-grade heat and high-grade heat regenerator and the low-grade heat reboiler; and/or,
the combined low-grade heat and high-grade heat regenerator and the high-grade heat reboiler are in fluid communication such that solvent comprising carbon dioxide (CO₂) passes between the combined low-grade heat and high-grade heat regenerator and the high-grade heat reboiler.

22. The method of claim 19, wherein the low-grade heat reboiler is positioned part-way down the combined low-grade heat and high- grade heat regenerator.

23. The method of claim 1, wherein a gas which does not dissolve into or react with the solvent (optionally inert gases such as hydrogen or nitrogen) is introduced into the reboiler(s) and/or the regenerator(s) to reduce the temperature in the reboiler(s) and/or the regenerator(s), thereby enabling the use of low-grade heat exclusively, or low-grade heat in combination with high grade heat.

24. The method of claim 1, wherein the step of providing a solvent comprising carbon dioxide (CO₂) comprises providing a CO₂ rich solvent; optionally, a CO₂ rich solvent with a concentration of carbon dioxide of from 2 to 3.3 mol L⁻¹.

25. The method of claim 1, wherein the formed carbon dioxide (CO₂) lean solvent is a carbon dioxide (CO₂) lean solvent with a concentration of carbon dioxide from 0.0 to 0.7 mol L⁻¹.

26. The method of claim 1, wherein the step of providing a solvent comprising carbon dioxide (CO₂) further comprises:
contacting a flue gas with carbon dioxide (CO₂) lean solvent within one, two, three, four, five, six, seven, eight, nine or ten, or more, absorber columns, wherein the absorber column(s) is (are) in fluid communication with the low- grade heat regenerator and the low-grade heat reboiler.

27. The method of claim 26, wherein the absorber column(s) is (are) in fluid communication with the low-grade heat regenerator and the low-grade heat reboiler through a cross-over heat exchanger; or
wherein the absorber column(s) is (are) in fluid communication with a high-grade heat regenerator and the high- grade heat reboiler through a cross-over heat exchanger.

28. (canceled)

29. The method of claim 1, wherein the solvent is an intensified solvent; optionally, an intensified solvent comprising a tertiary amine, a sterically hindered amine, a polyamine, a salt and water; optionally, wherein the solvent is CDRMax.

30. A system for regenerating a solvent comprising carbon dioxide (CO₂), the system comprising:
a low-grade heat regenerator; and
a low-grade heat reboiler,
wherein the low-grade heat regenerator and the low-grade heat reboiler are each independently configured to regenerate the carbon dioxide (CO₂) lean solvent at a temperature in the range of from 60 to less than 120° C. (or, from 100 to 119° C.; or, from 100 to 115° C.).

31-50. (canceled)
